(19) United States
(12) Patent Application Publication
(10) Pub. No.: US 2024/0116777 A1
(43) Pub. Date: Apr. 11, 2024

(54) Method And Apparatus For Separation Of A Substance From Water

(71) Applicant: Opec Remediation Technologies Pty Ltd, Hornsby NSW (AU)

(72) Inventor: David Burns, Hornsby (AU)

(21) Appl. No.: 18/275,589

(22) PCT Filed: Feb. 2, 2022
(86) PCT No.: PCT/IB2022/050930

§ 371 Date: Aug. 2, 2023

(30) Foreign Application Priority Data
Feb. 2, 2021 (AU) 2021900217

(51) Int. Cl. C02F 1/24; C02F 9/00

(52) U.S. Cl. CPC C02F 1/24; C02F 9/00; C02F 2101/36

(57) ABSTRACT

A method and apparatus is disclosed for separating an amount of an amphiphilic contaminant substance such as PFAS from water. The method comprising the steps of admitting the water which contains the substance into a flotation cell chamber, and then introducing a flow of gas thereinto. The gas is introduced by several different apparatus options for efficient aeration of the chamber, depending on the water being treated. The introduced gas produces a froth layer which is formed at, and which rises above, an interface with the contents of the chamber. The froth layer includes an amount of water and also a concentrated amount of the contaminant substance when compared with its initial concentration. The process then involves collapsing and removing the froth layer, with several options for removing the PFAS from that liquid by re-flotation to reconcentrate the PFAS, or absorption onto a solid substrate material. The treated water an also pass out of the chamber through an absorptive treatment device to remove an amount of the substance not already recovered in the foamate.

### TECHNICAL FIELD

This disclosure relates to an apparatus for separation of a substance from water and to a method for use of the separation apparatus. In one form, the apparatus and method can be applied to removal of contaminant organic material present in groundwater which has been extracted from a body of ground. However, the apparatus and method can also be applied to the removal of non-organic materials or contaminants from all types of contaminated water sources.

### BACKGROUND OF THE DISCLOSURE

Perfluoroalkyl or polyfluoroalkyl substances (PFAS) embody a range of poly fluorinated alkyl substances (including but not limited to carboxylic acids, alkyl sulfonates, alkyl sulfonamido compounds and fluoro telemeric compounds of differing carbon chain lengths and precursors of these). PFAS have found use in a wide variety of applications including as a specialised fire-fighting product, or for impregnation or coating of textiles, leather and carpet, or for carpet cleaning compounds, as well as in aviation hydraulic fluids, metal plating, agricultural (insect traps for certain types of ants), photo-imaging, electronics manufacture and non-stick cookware applications.

Higher order PFAS degrade to specific end-point PFAS chemicals (including but not limited to perfluorooctane sulfonate (PFOS), perfluorooctanoic acid (PFOA) and perfluorohexane sulfonate (PFHxS). These priority compounds of concern are resistant to biotic or abiotic degradation and thus are persistent in the environment. They are recalcitrant, bio-accumulative and known to have contaminated soils, groundwaters and drinking water supplies.

PFAS are known to have contaminated groundwater, including drinking water supplies. PFOS, PFHxS, and PFOA have published human health and environmental regulatory criteria in most developed world jurisdictions. Additional PFAS compounds are expected to be identified as contaminants of concern as new research toxicology data indicates potential risk associations. Remedial methods are needed to treat priority PFAS compounds.

Technology used to remove volatile organic compounds (VOC) by bubbling air through groundwater or in groundwater wells (also known as “air stripping”) is known in a number of publications. However, it is also known that such techniques do not work to treat groundwater with PFAS contamination. In a recent study, data is presented from a US location contaminated by PFAS where air-stripping had been previously used to remove VOCs, but more than 25 years after that activity, the site under investigation still had high, persistent PFAS contamination requiring remediation (Environ. Sci. Pollut. Res (2013) 20:1977-1992pp). While they are soluble, most long-chain PFAS (including PFOS and PFOA have a low, to very low, vapour pressure, which means they do not volatilise easily, so air-stripping is therefore not an ineffective remedial treatment.

Known technology used to treat PFAS contaminated groundwater is based on two approaches: “pump and treat” and “in-situ chemical treatment”.

“Pump and treat” is a conventional approach of pumping groundwater via extraction wells drilled into the ground to the surface, then treating the collected water. The treated water is then directed toward a suitable endpoint, for example for irrigation or re-injection back into the ground (which in many locations is not permissible), or by disposal into a sewerage or a waste treatment facility. This technique is costly because of the expense of transporting large quantities of water from place to place.

In such an approach, there are a wide variety of technologies used by waste facilities to treat water containing PFAS, including any or a combination of the following: (a) absorption by passage through an activated carbon media, most commonly in the form of granular activated carbon (GAC); (b) absorption by passage through a clay based media; (c) filtration by reverse osmosis (RO) membranes, and (d) absorption by passage through an ion exchange resin. In general, the treatment agents used in these technologies are either sensitive to fouling by non-compatible substances or cannot be easily regenerated and require disposal (typically to landfill) after they have reached maximum capacity.

There are currently no commercially viable technologies available using chemical approaches that are capable of degrading or destroying many of the key PFAS compounds of concern where they are present in low concentrations in large volumes of water.

Pump and treat systems are usually required to operate for extended periods over many years, and the treatment volumes are very large—as a result, the treatment plant equipment is also large. Capital and operating costs are typically high due to treatment plant size and long operational time periods (years, or even decades).

“In-situ chemical treatment” typically involves sub-surface application of a reactive agent which denatures or neutralises the target contaminant (PFAS). Subsurface application of the agent may include direct injection as a concentrated liquid, slurry or gas, or excavation/construction of a sub-surface barrier wall. The reactive agent may be oxidising (for example, hydrogen peroxide, persulfate or permanganate), reductive (for example, zero valent iron) or adsorptive (for example, superfine GAC slurry, clay). However, PFAS are recalcitrant, and laboratory studies have found limited success with performance of these reagents. Laboratory studies have also found that adsorption of PFAS by GAC is reversible (that is, not permanent).

Groundwater wells are known in the art to allow the circulation below the subsurface by moving groundwater using pumping methods within a well chamber. Such wells can involve complex, multiple screen sections in side walls, which may need to be separated by packers or low permeability barriers. Traditionally such wells have been used to treat groundwater containing volatile compounds, followed by vapour extraction, or to oxygenate the ground which surrounds a well, for example for purposes of in-situ aerobic bioremediation, or to introduce other liquid or colloidal substances into the groundwater.

Surface drains connected to a large drainage networks contaminated by PFAS (ie. soils) continue to be a significant risk to human health and the environment due to the high mass-flux potential during wet weather events. In addition, mobility of PFAS impacted soils have the potential to re-contaminate remediated surface drain infrastructure after subsequent heavy rainfall/flooding events.

It has become apparent that there are no suitable technologies which overcome the cost, scale and risk of the known techniques when applying them to try to neutralise PFAS.

### SUMMARY

In a first aspect, embodiments are provided of a method of separating an amount of a substance from water which is contaminated with the substance, the method comprising the steps of:
admitting an amount of the water, which includes an initial concentration of the substance, into a chamber via an inlet thereinto;
introducing a flow of gas into the chamber, wherein said introduced gas induces the water in the chamber to flow, and produce a froth layer which is formed at, and which rises above, an interface with the said flow of water and of introduced gas in the chamber, the froth layer including an amount of water and also a concentrated amount of the substance when compared with its initial concentration;
removing at least some of the froth layer from an upper portion of the chamber; and then
passing a flow of the water from the chamber through an absorptive treatment device which is arranged to remove therefrom a further amount of the substance not already removed in the froth layer.

In some embodiments, the flow of gas and the production of the froth layer is continuous.

In some embodiments, the method further comprises the step of controlling the water content of the froth layer which rises above the interface to influence the concentration of the substance therein.

In certain embodiments, the step of controlling the water content of the froth layer is by of the group comprising: controlling a physical parameter of the flow of introduced gas; and controlling a physical parameter of the froth layer.

In one form of this, the step of controlling a physical parameter of the flow of introduced gas comprises use of a flow controller and an inlet valve for controlling the flow of said introduced gas into the chamber.

In another form of this, the step of controlling a physical parameter of the froth layer comprises the use of a froth depth regulation device for maintaining a depth of the froth layer above the interface. In a further form of this, the step of controlling a physical parameter of the froth layer further comprises use of a device for confining the crosssectional flow path of the froth in the upper portion of the chamber, resulting in drainage of said froth layer.

In some embodiments, the froth layer is collapsed during said removal step from the upper portion of the or each chamber, prior to undergoing a secondary treatment step. In one form of this, the method further includes the steps of:
passing the collapsed froth layer including the concentrated substance into a further chamber, said further chamber having a gas introduction device which in use admits gas thereinto, the introduced gas for inducing flow within the further chamber, and for producing a further froth layer which is formed at, and which rises above an interface with the said flow of the collapsed froth layer and introduced gas in the further chamber, the further froth layer including an amount of water and also a more concentrated amount of the substance when compared with its concentration in the collapsed froth layer, and
removing at least some of the further froth layer from an upper portion of the respective further chamber;
whereupon a remaining portion of the collapsed froth layer in the further chamber is passed through the absorptive treatment device.

In other forms of this, the secondary treatment step for treating the collapsed froth layer including the concentrated substance uses at least one of the processes of the group comprising: absorption (using an activated carbon, a clay, or an ion exchange resin), filtration (using reverse osmosis membranes).

In some embodiments, the substance is at least one of a perfluoroalkyl substance or a polyfluoroalkyl substance (PFAS). In some forms of this, the perfluoroalkyl or polyfluoroalkyl substance (PFAS) includes one or more of the group comprising: perfluoro-octane sulfonate (PFOS); perfluoro-octanoic acid (PFOA); perfluoro-n-hexane sulfonic acid, (PFHxS); perfluorononanoic acid (PFNA); perfluorodecanoic acid (PFDA/Ndfda); 6:2-fluorotelomer sulphonate compounds (6:2 FT S); 8:2-fluorotelomer sulphonate compounds (8:2 FTS); and perfluoro-octanoic acid (PFHpA).

In some embodiments, the method further includes the step of pre-selecting an absorptive solid material for the absorptive treatment device. In some forms of this, the pre-selected absorptive solid material is a composite particle comprising an aggregate core which is surface-coated with a reactive absorbent material. In some forms of this, the adsorptive solid material is housed in a permeable reactive barrier (PRB).

In some embodiments, the preselected absorptive solid material is suitable for absorption of one or more perfluoroalkyl or polyfluoroalkyl substances (PFAS) from the group comprising: perfluoro-octane sulfonate (PFOS); perfluoro-octanoic acid (PFOA); perfluoro-n-hexane sulfonic acid, (PFHxS); perfluorononanoic acid (PFNA); perfluorodecanoic acid (PFDA/Ndfda); 6:2-fluorotelomer sulphonate compounds (6:2 FTS); 8:2-fluorotelomer sulphonate compounds (8:2 FTS); and perfluoro-octanoic acid (PFHpA).

In some embodiments, the preselected absorptive solid material is suitable for absorption of one or more perfluoroalkyl or polyfluoroalkyl substances (PFAS) from the group comprising: perfluoro-hexanoic acid (PFHxA); perfluoro-butane sulfonic acid, (PFBS); and perfluoro-pentane sulfonic acid (PFBeS).

In some embodiments, the method further comprises the step of removing solid material from the water prior to it flowing into the chamber. In one form of this, the step of removing solid material is by a process of at least one of the group comprising: sedimentation and screening.

In some embodiments, the said contaminated liquid flows through the or each chamber and the absorptive treatment device passively under the influence of gravity.

In a second aspect, embodiments are provided of a method of separating an amount of a substance from water which is contaminated with the substance, the method comprising the steps of:
admitting said water, which includes an initial concentration of the substance, to move under the influence of gravity into a chamber via an inlet thereinto, until the chamber is filled to a pre-determined extent; and then
introducing a flow of gas into the chamber, wherein said introduced gas induces the water in the chamber to flow, and produce a froth layer which is formed at, and which rises above, an interface with the said flow of water and of introduced gas in the chamber, the froth layer including an amount of water and also a concentrated amount of the substance when compared with its initial concentration;
removing at least some of the froth layer from an upper portion of the chamber; and then
allowing water remaining in the chamber to be discharged by flowing out of the chamber via an exit therefrom.

In some embodiments, the method further comprises the step of passing said flow of water discharged from the chamber through an absorptive treatment device which is arranged to remove therefrom a further amount of the substance not already removed in the froth layer. In one form of this, the said flow of water discharged from the chamber passes through the absorptive treatment device passively, and in response to the influence of gravity.

In some embodiments, the steps of the method of the second aspect are also as described for the first aspect.

In a third aspect, embodiments are provided of an apparatus for separating an amount of a substance from water which is contaminated with an initial concentration of the substance, the apparatus comprising one or more chambers which:
are arranged in use to admit the movement of said contaminated water under the influence of gravity via an inlet thereinto, until the chamber is filled to a pre-determined extent;
have a respective gas introduction device, in use the introduced gas for inducing the water in the chamber to flow, and for producing a froth layer which is formed at, and which rises above an interface with the said flow of water and introduced gas in the chamber, the froth layer including an amount of water and also a concentrated amount of the substance when compared with its initial concentration;
have a device in use for removing at least some of the froth layer from a respective upper portion thereof; and
have an exit, in use to allow a discharge flow of remaining water therefrom.

In some embodiments of the apparatus, an absorptive treatment device is placed in fluid communication with said exit from the chamber(s), being arranged in use to receive said discharge flow of the water therefrom, and to remove a further amount of the substance from that water not already removed in the froth layer. In some forms of this, the flow of water from the chamber exit through the absorptive treatment device is passive, in response to the influence of gravity.

In some embodiments of the apparatus, if two or more chambers are present, they are arranged to operate independently of one another by being configured to admit and to discharge water using a parallel flow arrangement.

In some embodiments of the apparatus, the or each chamber is an elongate cylindrical vessel having an inlet comprising an opening in an upper portion of an external side wall thereof, said opening having a closure which is operable to control the admission of said contaminated water into the chamber from an adjacent body of said water.

In some embodiments of the apparatus, the or each chamber has an exit comprising an opening in a lower portion of an external side wall thereof, said opening having a closure which is operable to control the discharge of said remaining water from the chamber.

In some embodiments of the apparatus, control of the water content of the froth layer comprises apparatus for at least one of: controlling a physical parameter of the flow of introduced gas; and controlling a physical parameter of the froth layer.

In one form of this, the apparatus for control of a physical parameter of the flow of introduced gas into the chamber comprises the use of a flow controller and an inlet valve on a gas delivery line, responsive to a measurement of one of the group comprising: water content of the froth layer; froth stability of the froth layer; location of the interface in the chamber.

In some embodiments, the apparatus for control of a physical parameter of the froth layer, comprises the use of a froth depth regulation device for maintaining a depth of the froth layer above the interface, wherein the froth depth regulation device is selected from the group comprising: a device which is moveably positionable within the chamber in response to movement of the location of the interface; and a device which is arranged at a fixed location in relation to the chamber, and the location of the interface is responsive to at least one of the flow of the introduced gas, and an inlet flow of the water.

In one form of this, the froth depth regulation device is arranged for confining the cross-sectional flow path of the froth as it is leaving the chamber, resulting in froth confinement and drainage of said froth layer.

In some embodiments, the apparatus comprises a froth layer removal device in which at least some of the froth layer is collapsed during removal of at least some of the froth layer from the uppermost region of the chamber, and prior to a secondary treatment step. In certain forms of this, the froth layer collapse device includes mechanical apparatus from the group comprising: a foam breaker, a vacuum extraction device, and a froth extraction head.

In some embodiments, the apparatus also comprises a further foam fractionation chamber being in fluid communication with the or each of said chamber(s) in use, the further chamber arranged to:
admit thereinto the collapsed froth layer including the concentrated substance, until the chamber is filled to a pre-determined extent,
have a gas introduction device which in use admits gas thereinto, the introduced gas for inducing flow within the chamber, and for producing a further froth layer which is formed at, and which rises above an interface with the said flow of the collapsed froth layer and introduced gas in the further chamber, the further froth layer including an amount of water and also a more concentrated amount of the substance when compared with its concentration in the collapsed froth layer;
have a device in use for removing at least some of the further froth layer from an upper portion of the further chamber; and
have an exit, in use to allow a flow of remaining collapsed froth layer to be discharged therefrom.

In some embodiments using the further foam fractionation chamber apparatus (or hyperconcentrator), an absorptive treatment device is placed in fluid communication with said exit from the further chamber, being arranged in use to receive said discharge flow of the remaining water therefrom, and to remove a further amount of the substance from that water not already removed in the further froth layer.

In one form of this, said absorptive treatment device includes the use of an absorptive solid material, for example a composite particle comprising an aggregate core which is surface-coated with a reactive absorbent material. In some forms, the adsorptive solid material is housed in a permeable reactive barrier (PRB).

In some other embodiments, the absorptive solid material is from the group comprising: an activated carbon, a clay, or an ion exchange resin.

In some embodiments, the apparatus further comprises another secondary treatment device in use for treating the collapsed froth layer for removal of the concentrated substance, wherein the treatment device includes at least one of the group comprising: filtration (using reverse osmosis membranes); vacuum distillation; drum drying.

In some of the aforementioned embodiments, the selected absorptive solid material is suitable for absorption of one or more perfluoroalkyl or polyfluoroalkyl substances (PFAS) from the group comprising: perfluoro-octane sulfonate (PFOS); perfluoro-octanoic acid (PFOA); perfluoro-n-hexane sulfonic acid, (PFHxS); perfluorononanoic acid (PFNA); perfluorodecanoic acid (PFDA/Ndfda); 6:2-fluorotelomer sulphonate compounds (6:2 FTS); 8:2-fluorotelomer sulphonate compounds (8:2 FTS); and perfluoro-octanoic acid (PFHpA).

In some of the aforementioned embodiments, the selected absorptive solid material is suitable for absorption of one or more perfluoroalkyl or polyfluoroalkyl substances (PFAS) from the group comprising: perfluoro-hexanoic acid (PFHxA); perfluoro-butane sulfonic acid, (PFBS); and perfluoro-pentane sulfonic acid (PFBeS).

In some embodiments of the apparatus, the gas introduction device comprises a submersible aerator which, in use, is arranged to be at least partially submerged in the water admitted into the chamber.

In some embodiments, the submersible aerator is arranged in use to receive gas from outside the chamber, and to expel said gas into the water admitted into the chamber.

In some embodiments, the submersible aerator is adapted for inducing a generally rotational or swirling flow of the water and expelled gas in the chamber with an axis of rotation aligned with an elongate axis of the aerator,

In some embodiments, the vertical axis of the aerator is approximately aligned in use with a central, vertical axis of a respective chamber. In examples of this alignment, the rotational or swirling flow of the water has a generally laminar flow pattern as it moves about an interior peripheral wall of the chamber.

In some embodiments, as the gas is expelled from the aerator in use, it is dispersed into the water in the chamber in the form of bubbles.

In some particular embodiments, the submersible aerator comprises a plurality of elongate, vertically axially oriented conduits, generally aligned with one another over their major lengths, and arranged to extend into an interior of the chamber, for receiving and expelling the gas into the chamber in use.

In some embodiments of this, an end portion of each conduit has a central axis which is angled at 90 degrees to the vertical axis of the major length of each conduit, said end portion lying in a notional horizontal plane, and furthermore, the end portion of each conduit has a central axis which is oriented at an angle of less than 90 angle degrees with respect to a notional vertical plane passing through the vertical axis of the respective major length.

In one form of this, an end portion of each conduit has a central axis which is oriented at an angle of less than 45 angle degrees with respect to a notional vertical plane passing through the vertical axis of the respective major length, and in an even more particular example, an end portion of each conduit has a central axis which is oriented at an angle of more than 25 angle degrees with respect to a notional vertical plane passing through the vertical axis of the respective major length.

In some embodiments, the end portion of each conduit is fitted with an internal venturi nozzle so that in use, as gas flows via the elongate conduit and is expelled via the end portion, a dispersion of bubbles is created.

In other particular embodiments, the submersible aerator comprises an impeller zone in which is located a rotatable impeller having a series of pumping vanes, along with a series of fluid exit guide vanes positioned around the circumference of the impeller zone, such that when operably rotated in use, the aerator:
draws in gas from outside the impeller zone by generating a negative pressure (or suction) behind the impeller blades, and
draws a flow of the contaminated water into the impeller zone from the chamber and subsequently expels that flow of water back into the chamber,
wherein the gas drawn into the impeller zone becomes intimately mixed with the flow of water therein, under the mechanical force of the impeller pumping vanes and exit guide vanes, to create a dispersion of bubbles in that flow of water.

In some embodiments, the submersible aerator comprises an elongate conduit arranged to extend from outside the chamber to the impeller zone, through which the gas is drawn into the impeller zone in use.

In some embodiments, the submersible aerator comprises a plurality of fluid exit guide vanes, arranged to guide the flow of the water with dispersed gas therein, as it is expelled into the chamber interior.

In some particular embodiments, the exit guide vanes have a central axis which is angled at 90 degrees to the vertical axis of rotation of the impeller, and lie in a notional horizontal plane, and furthermore, the exit guide vanes have a central axis which is oriented at an angle of less than 90 angle degrees with respect to a notional vertical plane passing through the vertical axis of rotation of the impeller.

In one form of this, the exit guide vanes have a central axis which is oriented at an angle of less than 45 angle degrees with respect to a notional vertical plane passing through the vertical axis of rotation of the impeller, and in an even more particular example of this, the exit guide vanes have a central axis which is oriented at an angle of more than 25 angle degrees with respect to a notional vertical plane passing through the vertical axis of rotation of the impeller.

In some embodiments, the gas introduction device additionally comprises an aerator in the form of a microbubble or nanobubble generator arranged to be in fluid communication with the water admitted into the chamber.

In some embodiments, the microbubble or nanobubble generator is arranged in use to receive gas from outside the chamber, and to generate microbubbles or nanobubbles in a flow stream of water which is continuously removed from and returned to the chamber. In some alternative embodiments, the microbubble or nanobubble generator is arranged in use to receive gas from outside the chamber, and to generate microbubbles or nanobubbles in a flow stream of water which is intermittently removed from and/or returned into the chamber.

In a fourth aspect, embodiments are provided of an apparatus for for separating an amount of a substance from water which is contaminated with an initial concentration of the substance, the apparatus comprising one or more chambers which:
are arranged in use to admit the movement of said contaminated water via an inlet thereinto, until the chamber is filled to a pre-determined extent;
have a respective gas introduction device, in use the introduced gas for inducing the water in the chamber to flow, and for producing a froth layer which is formed at, and which rises above an interface with the said flow of water and introduced gas in the chamber, the froth layer including an amount of water and also a concentrated amount of the substance when compared with its initial concentration;
have a device in use for removing at least some of the froth layer from a respective upper portion thereof; and
have an exit arranged in use to allow a discharge flow of remaining water to pass from the chamber and be received by an absorptive treatment device which is arranged to remove therefrom a further amount of the substance not already removed in the froth layer.

In some embodiments, the or each chamber is arranged in use to admit the movement of said contaminated water under the influence of gravity via the inlet thereinto, until the chamber is filled to the pre-determined extent.

In some embodiments, the features of the apparatus of the fourth aspect are also as described for the third aspect.

In a fifth aspect, embodiments are provided of a method of separating an amount of a substance from water which is contaminated with the substance, the method comprising the steps of:
admitting an amount of the water, which includes an initial concentration of the substance, into a chamber via an inlet thereinto;
introducing a flow of gas into the chamber, wherein said introduced gas induces the water in the chamber to flow, and produce a froth layer which is formed at, and which rises above, an interface with the said flow of water and of introduced gas in the chamber, the froth layer including an amount of water and also a concentrated amount of the substance when compared with its initial concentration;
removing at least some of the froth layer from an upper portion of the chamber; and then
allowing water remaining in the chamber to be discharged by flowing out of the chamber via an exit therefrom.

In some embodiments, the method also comprises the step of passing said flow of water discharged from the chamber through an absorptive treatment device which is arranged to remove therefrom a further amount of the substance not already removed in the froth layer.

In some embodiments, the method also comprises the step of allowing said flow of water discharged from the chamber to pass through the absorptive treatment device passively, and in response to the influence of gravity.

In some embodiments, the steps of the method of the fifth aspect are also as described for the first aspect.

In a sixth aspect, embodiments are provided of apparatus for separating an amount of a substance from water which is contaminated with an initial concentration of the substance, the apparatus comprising one or more chambers which:
are arranged in use to admit the movement of said contaminated water via an inlet thereinto, until the chamber is filled to a pre-determined extent;
have a respective gas introduction device, in use the introduced gas for inducing the water in the chamber to flow, and for producing a froth layer which is formed at, and which rises above an interface with the said flow of water and introduced gas in the chamber, the froth layer including an amount of water and also a concentrated amount of the substance when compared with its initial concentration;
have a device in use for removing at least some of the froth layer from a respective upper portion thereof; and
have an exit, in use to allow a discharge flow of remaining water therefrom.

In some embodiments, the or each chamber is arranged in use to admit the movement of said contaminated water under the influence of gravity via the inlet thereinto, until the chamber is filled to the pre-determined extent.

In some embodiments, the features of the apparatus of the sixth aspect are also as described for the third aspect.

In some embodiments, said gas introduction device comprises one or more gas inlet flow pipes which are arranged about an axial centreline of the chamber and which extend into an interior of the chamber from an uppermost region of the vessel, in use for admitting gas into the chamber.

In one form of this, the lowermost distal end of the one or more gas inlet flow pipes which extend into the chamber interior are adapted for inducing a generally rotational or swirling flow of said introduced gas and water, with an axis of rotation of that swirling flow being aligned with an elongate axis of the chamber, said swirling flow being generally laminar along the interior peripheral wall of the chamber.

In one particular form of this, the adaptation of the distal end of the or each gas inlet flow for inducing said rotational or swirling flow within the chamber is a plurality of 90 angle degree pipe bends which are each arranged to discharge the gas inlet flow in a direction which is generally tangential to the axial centreline of the chamber.

In a seventh aspect, embodiments are provided of a method of separating an amount of a substance from water which is contaminated with the substance, the method comprising the steps of:
admitting an amount of the water, which includes an initial concentration of the substance, into a chamber via an inlet thereinto;
introducing a flow of gas into the chamber, wherein said introduced gas induces the water in the chamber to flow, and produce a froth layer which is formed at, and which rises above, an interface with the said flow of water and of introduced gas in the chamber, the froth layer including an amount of water and also a concentrated amount of the substance when compared with its initial concentration;
removing at least some of the froth layer from an upper portion of the chamber such that during said removal step the froth layer collapses, prior to it undergoing a secondary treatment step which uses at least one of the processes of absorption or filtration to remove said concentrated substance from the water, and
allowing water remaining in the chamber to be discharged by flowing out of the chamber via an exit therefrom.

In some embodiments, the secondary treatment step of absorption uses a pre-selected absorptive solid material.

In some embodiments, the pre-selected absorptive solid material is at least one from the group comprising: an activated carbon, a clay, and an ion exchange resin.

In some embodiments, the pre-selected absorptive solid material is a composite particle comprising an aggregate core which is surface-coated with a reactive absorbent material.

In some embodiments, the secondary treatment step of filtration uses a reverse osmosis membrane.

In some embodiments, the method further comprises the step of passing said flow of water discharged from the chamber through an absorptive treatment device which is arranged to remove therefrom a further amount of the substance not already removed in the froth layer.

In some embodiments, the absorptive treatment device comprises a pre-selected absorptive solid material.

In the seventh and eighth aspects, the substance is organic, in some cases the substance is an amphiphilic substance, and in some cases the substance is at least one of a perfluoroalkyl substance or a polyfluoroalkyl substance (PFAS).

In one form of this, the PFAS includes one or more of the group comprising the following substances:
perfluoro-octane sulfonate (PFOS); perfluoro-octanoic acid (PFOA); perfluoro-n-hexane sulfonic acid (PFHxS); perfluoro-nonanoic acid (PFNA); perfluoro-decanoic acid (PFDA/Ndfda); 6:2-fluorotelomer sulphonate compounds (6:2 FTS); 8:2-fluorotelomer sulphonate compounds (8:2 FTS); and perfluoro-octanoic acid (PFHpA); poly fluorinated carboxylic acids, alkyl sulfonates and alkyl sulfonamido compounds; and fluorotelemeric compounds, each having differing carbon chain lengths; and including precursors of these.

In some embodiments of the method, the preselected absorptive solid material is suitable for absorption of one or more perfluoroalkyl or polyfluoroalkyl substances (PFAS) from the group comprising the following substances:
perfluoro-octane sulfonate (PFOS); perfluoro-octanoic acid (PFOA); perfluoro-n-hexane sulfonic acid (PFHxS); perfluoro-nonanoic acid (PFNA); perfluoro-decanoic acid (PFDA/Ndfda); 6:2-fluorotelomer sulphonate compounds (6:2 FTS); 8:2-fluorotelomer sulphonate compounds (8:2 FTS); and perfluoro-octanoic acid (PFHpA); poly fluorinated carboxylic acids, alkyl sulfonates and alkyl sulfonamido compounds; and fluorotelemeric compounds, each having differing carbon chain lengths; and including precursors of these.

In some embodiments, the preselected absorptive solid material is suitable for absorption of one or more perfluoroalkyl or polyfluoroalkyl substances (PFAS) from the group comprising the following amphiphilic substances: perfluoro-hexanoic acid (PFHxA); perfluoro-butane sulfonic acid, (PFBS); and perfluoro-pentane sulfonic acid (PFBeS).

In some embodiments, the method further comprises the step of removing solid material from the water prior to it flowing into the chamber.

In some embodiments, further steps of the method are as defined in the first aspect.

In an eighth aspect, embodiments are provided of an apparatus for separating an amount of a substance from water which is contaminated with an initial concentration of the substance, the apparatus comprising one or more chambers which:
are arranged in use to admit the movement of said contaminated water via an inlet thereinto, until the chamber is filled to a pre-determined extent;
have a respective gas introduction device, in use the introduced gas for inducing the water in the chamber to flow, and for producing a froth layer which is formed at, and which rises above an interface with the said flow of water and introduced gas in the chamber, the froth layer including an amount of water and also a concentrated amount of the substance when compared with its initial concentration;
have a froth layer removal device in use for removing at least some of the froth layer from a respective upper portion of a chamber, such that during removal the froth layer collapses, prior to it passing to a secondary treatment device which uses one of the processes of absorption and filtration to remove said concentrated substance from the water; and
have an exit, in use to allow a discharge flow of remaining water therefrom.

In some embodiments, the or each froth layer removal device includes mechanical apparatus from the group comprising: a foam breaker, a vacuum extraction device and a froth extraction head.

In some embodiments, the secondary treatment device includes at least one of the group comprising: absorption using a pre-selected absorptive solid material; filtration using reverse osmosis membranes; vacuum distillation; drum drying.

In some embodiments, the pre-selected absorptive solid material is at least one from the group comprising: an activated carbon; a clay; an ion exchange resin; a composite particle comprising an aggregate core which is surface-coated with a reactive absorbent material.

In some embodiments, the apparatus further comprises the features as defined in earlier aspects herein.

Other aspects, features, and advantages will become further apparent from the following detailed description when read in conjunction with the accompanying drawings which form a part of this disclosure and which illustrate, by way of example, principles of the inventions disclosed.

### DESCRIPTION OF THE FIGURES

The accompanying drawings facilitate an understanding of embodiments of the apparatus, system and method of the disclosure.

FIG. 1 shows a schematic, perspective, exploded view of an apparatus for separating an amount of a substance from water which is contaminated with the substance, the apparatus including two adjacent, elongate, cylindrical flotation chambers arranged in use to operate in parallel with one another, and each being in fluid communication with an adjacent re-flotation chamber, in accordance with one embodiment of the present disclosure.

FIG. 2 shows a schematic, perspective, part-sectional view of an apparatus for separating an amount of a substance from water which is contaminated with the substance, in accordance with the embodiment of FIG. 1.

FIG. 3 shows a schematic, part-sectional, side elevation view of an apparatus for separating an amount of a substance from water which is contaminated with the substance, in accordance with the embodiment of FIG. 1, when viewed at a cross-sectional plane A-A through the flotation chambers.

FIG. 3A shows a schematic, end elevation view of an apparatus for separating an amount of a substance from water which is contaminated with the substance, in accordance with the embodiment of FIG. 3, showing the cross-sectional plane A-A through the flotation chambers.

FIG. 4 shows a schematic, side elevation, part-sectional view of part of an apparatus for separating an amount of a substance from water which is contaminated with the substance, in accordance with the embodiment of FIG. 1, in particular showing the detail of one embodiment of a gas introduction device comprising elongate, vertically axially oriented conduits, used for introducing gas for foam separation/flotation into a flotation chamber.

FIG. 5 shows a schematic, perspective view of the elongate conduits for introducing gas or air for foam separation/flotation into the chambers, in accordance with the embodiment of FIG. 4.

FIG. 6 shows a schematic, side elevation view of the elongate conduits for introducing gas or air for foam separation/flotation into the chambers, in accordance with the embodiment of FIG. 3, and the area indicated by Detail B.

FIG. 7 shows a schematic, perspective, top view of an on-water process plant for separating an amount of a substance from water which is contaminated with the substance, the apparatus including two adjacent flotation chambers arranged in parallel and in fluid communication with an adjacent re-flotation chamber, in accordance with one embodiment of the present disclosure. The drawing gives details of how the contaminated water passes through a basic trash screen, and then by gravity flow into the debris pre-treatment (removal) zone, then into the primary froth flotation stage, then into the secondary re-flotation stage and finally the remaining water from those stages passes into the optional adsorption stage for removal of shorter-chain PFAS molecules, before the final treated water is discharged via gravitation head into a plastic pipe and then out of the reservoir.

FIG. 8 shows a further schematic, perspective, top view of an on-water process plant for separating an amount of a substance from water which is contaminated with the substance using foam separation/flotation in the chambers, in accordance with the embodiment of FIG. 7.

FIG. 9 shows a schematic, perspective, top view of three of the on-water process plants for separating an amount of a substance from water which is contaminated with the substance, in accordance with the embodiment of FIG. 7. The only difference between FIG. 7 and the equipment shown in FIG. 9 is that there are three identical, adjacent on-water process plants extending into the body of water, and all located alongside each other, the modularity of the design readily allowing an increase in treatment capacity/throughput.

FIG. 10 shows a further schematic, perspective, top view of an on-water process plant for separating an amount of a substance from water which is contaminated with the substance using foam separation/flotation in the chambers, in accordance with the embodiment of FIG. 9.

FIG. 11 shows a schematic, perspective view of part of an apparatus for separating an amount of a substance from water which is contaminated with the substance, in accordance with the embodiment of FIG. 1, in particular showing one embodiment of a gas introduction device comprising vertically axially oriented submersible aeration device, having a rotatable impeller with a series of pumping vanes, and a series of fluid exit guide vanes, used for introducing gas for foam separation/flotation into a flotation chamber.

FIG. 12 shows a top, plan view of the vertically axially oriented submersible aeration device, used for introducing gas for foam separation/flotation into a flotation chamber, in accordance with the embodiment of FIG. 11 and FIG. 12. In particular this shows further detail of the connection for the air inlet conduit, and the six (6) fluid exit guide vanes arranged to guide the expelled flow of water and dispersed gas out of the impeller zone.

FIG. 13 shows a side elevation view of the vertically axially oriented submersible aeration device, in accordance with the embodiment of FIG. 11. In particular, this shows the detail of the connection for the air inlet conduit, and three of the six (6) rectangular fluid exit guide vanes arranged to guide the expelled flow of water and dispersed gas out of the impeller zone.

FIG. 14 shows a cross-sectional, side elevation view of the vertically axially oriented submersible aeration device, in accordance with the embodiment of FIG. 11. In particular, this shows the internal detail of the impeller, impeller zone and guide vanes when viewed at a cross-sectional plane drawn through a horizontal midline of FIG. 12.

FIG. 15 shows a schematic, ¾ cross-sectional, side elevation view of the vertically axially oriented submersible aeration device, in accordance with the embodiment of FIG. 11. In particular, this shows the internal detail of the functioning of the impeller, impeller zone and guide vanes when viewed at a cross-sectional plane drawn through a horizontal midline of FIG. 12.

FIG. 16 shows a schematic, top and side elevation view of the vertically axially oriented submersible aeration device, in accordance with the embodiment of FIG. 11. In particular, in three parts A, B and C, this Figure shows the pathways of the six (6) flow streams of expelled water and dispersed gas out of the impeller zone creating a rising mass of air bubbles.

FIG. 17 shows a schematic, part-cross-sectional, side elevation view of the vertically axially oriented submersible aeration device, in accordance with the embodiment of FIG. 11. In particular, this shows the position of the aeration device at the floor of a flotation tank when the tank is viewed in a cross-sectional plane, showing the recirculation patterns of streams of expelled water and dispersed gas expelled out of the aeration device, creating a rising mass of air bubbles.

FIG. 18 shows a schematic, side elevation view of an exemplary microbubble generation system which can be combined in use with the submersible aeration device, in accordance with the embodiment of FIG. 11.

### DETAILED DESCRIPTION

This disclosure relates to various embodiments of a flotation cell and a flotation cell aeration system, and its method of use, for the removal of an organic contaminant from a body of water which is placed into that flotation cell for treatment. Typically, such contaminated water is obtained by extraction pumping from a nearby aquifer or groundwater well, or from some other water storage containment, and then subjected to froth or foam fractionation.

Water which is suitable for treatment by the apparatus and methods disclosed in this specification can have a very low, or even trace, level of organic contaminants which are dissolved or dispersed therein, and of particular interest are amphiphilic molecular compounds. Amphiphilic substances consist of molecules having a polar water-soluble group attached to a water-insoluble hydrocarbon chain, for example common surfactants (such as sodium dodecyl sulfate (SDS) an anionic surfactant, and cetyl-trimethyl-ammonium bromide (CTAB)), soaps, detergents, and lipoproteins. Amphiphilic substances can also include hazardous contaminants such as perfluoroalkyl substances or polyfluoroalkyl substances (PFAS).

As a result of having both lipophilic and hydrophilic portions, many amphiphilic compounds dissolve in water to some extent. The extent of the hydrophobic and hydrophilic portions determines the extent of partitioning. Soap is a common household amphiphilic surfactant compound. Soap mixed with water (polar, hydrophilic) is useful for cleaning oils and fats (non-polar, lipiphillic) from kitchenware, dishes, skin, clothing, and so on. When exposed to fluid mixing and the addition of gas bubbles such as air, the longer the carbon chain, the more likely it is that amphiphilic compounds preferentially come out of a water solution, and attached to a rising air bubble, forming a froth which will likely carry the hydrophobic material with it.

When the term “froth flotation” is used in the present specification, it may be interchangeably used with the terms “foam fractionation”, and “bubble fractionation”, since the apparatus and method that are employed in each instance are essentially the same, when operating in a two-phase mixture (that is, a mixture of a liquid and a gas). This is because the present process operates best when just a small amount of suspended solids is present in the water, giving a relatively low turbidity.

In an example which is presented in this specification, a stable wet foam can be produced by a froth flotation (or a foam fractionation) apparatus, in which water, which is contaminated with a sufficient (above minimum) concentration of an amphiphilic compound, is agitated, and air bubbles are introduced into, or produced by some means in, the contaminated water. The result is a stable wet foam which rises above the air/water interface at the upper surface level of the air/water mixture, and which carries most of the amphiphilic compounds out of solution. When the foam collapses, the flotation process yields a small volume of concentrated amphiphilic compounds in solution, when compared to the initial concentration in the contaminated water.

In a further example of using the froth flotation apparatus and method which is presented in this specification, the agitation and aeration of water in which only very low or trace levels of amphiphilic compounds are present, will likely be a very weak foam. The present inventors have shown that in such situations, by varying the aeration conditions provided in the flotation cell to deliver gas bubbles of various sizes and distribution throughout the cell volume, then over time, even an unstable or weak froth which forms at the upper surface of the contaminated water in the flotation cell can become more stable and thus be recovered, to thereby remove the trace amphiphilic compounds from the water.

In some embodiments described herein, the contaminated water supply is able to flow by gravity into that flotation cell. Typically, such contaminated water can have arisen from leaching of adjacent ground, or from a nearby contaminated aquifer or from a sudden rain event which has resulted in a certain level of organic contaminant(s) which have become dissolved or dispersed therein. A small amount of suspended solids may also be present, so that the water may have some turbidity.

In some alternative embodiments described herein, the contaminated water supply will require delivery into a flotation cell which is located on dry ground which, for example, is adjacent, or in proximity, to a body of contaminated water for treatment (and for which there is no limitation such as the equipment being “gravity-fed”). This is the case for some aspects of the aforementioned disclosure. The flow of contaminated water may have arisen in the same manner as will be described in the example of the gravity-flow system. Therefore, when the flotation cell and other associated treatment apparatus is described for a gravity-fed system (as in the second and third aspects of the aforementioned disclosure), it should be understood that the equivalent flotation cell and associated treatment apparatus can also be located and operated on dry ground, and the feed water entering the process, as well as the treated water exiting the process, can be conveyed to it, for example by pumping.

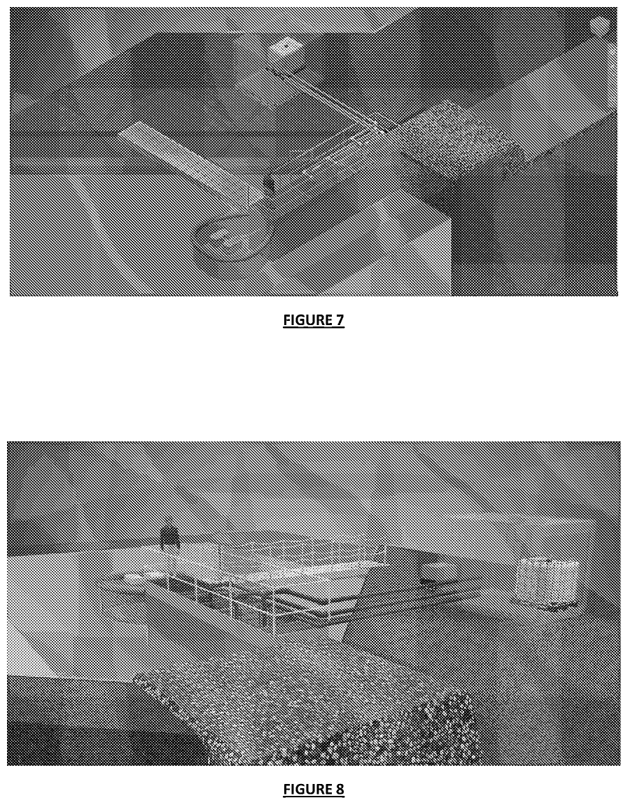

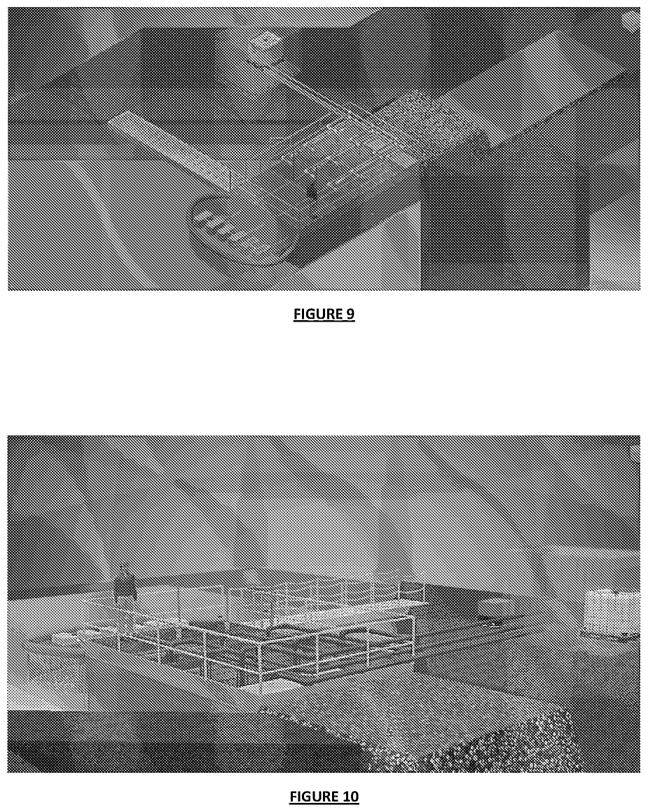

FIGS. 7 to 10 show some examples of an “in-water” or “on-water” process plant into which the water for treatment flows under the influence of gravity, and where the process plant is arranged for separating an amount of a contaminant substance from that water. The apparatus comprises a basic unit which includes two adjacent primary flotation chambers arranged in parallel with one another, both chambers being in fluid communication with an adjacent re-flotation chamber, in which the flotation concentrate of the primary foam fractionation stage is then subjected to a second stage flotation re-concentration process, to produce an even smaller volume of contaminant material in water.

FIGS. 7 to 10 show the arrangement of the contaminated water passes through a basic trash screen, and then flowing by reason of the gravity head of water in the dam into the water treatment plant of the present invention. The process plant is located “on-water” in the sense of being positioned atop the water reservoir, for example, in one arrangement it can be positioned on a vessel, or barge or pontoon or floating platform. In other arrangements the “on-water” process plant can be tethered to the floor of the body of water or located at the natural exit point from that water body (eg a spillway or weir).

In these embodiments, much of the treatment process that will be described involves positioning equipment which is largely arranged in a configuration which is below the water level, so that the natural gravitational flow of water that passes through the process plant can simply be effected by opening inlet and outlet valves, and as such the process plant can continue to operate, but it does not become a bottleneck if the reservoir should experience a sudden downpour or rain event which requires large amounts of water to be discharged from the water body, and in quantities which exceed the expected unit flow capacity.

As has already been stated, similar equipment that is arranged in a similar configuration can be operated above water level, and located on dry land. Such apparatus can receive a flow of water into the foam fractionation plant by the operation of feedwater pumps and discharge water pumps, the automated control of which can be performed in conjunction with the opening and closing of water valves positioned at inlets and outlets which are in fluid communication with the flotation cell interior. Embodiments of this location of foam fractionation operation are within the scope of the fifth and sixth aspect of the present disclosure, at least.

The water is processed using a debris pre-treatment (removal) zone to get rid of larger trash and objects, then into the primary froth flotation stage, then into the secondary re-flotation stage to concentrate up the PFAS molecules and finally the remaining water from those stages is passed into the optional adsorption stage for removal of shorter-chain PFAS molecules, before the final treated water is discharged via gravitation head into a plastic pipe and then out of the reservoir.

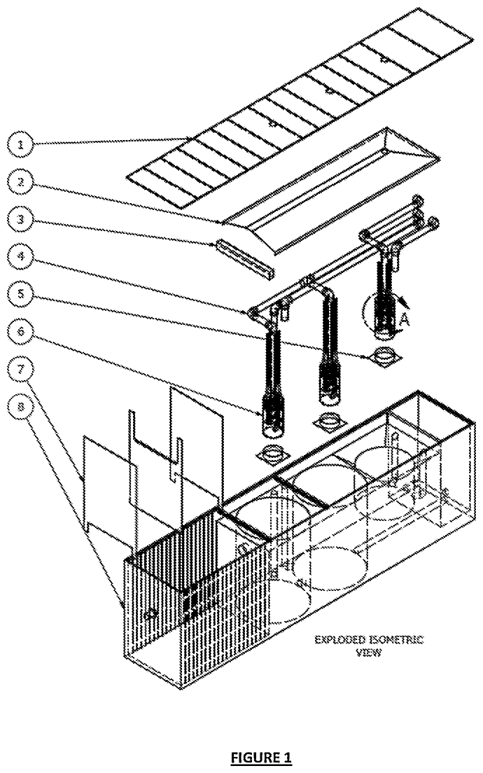

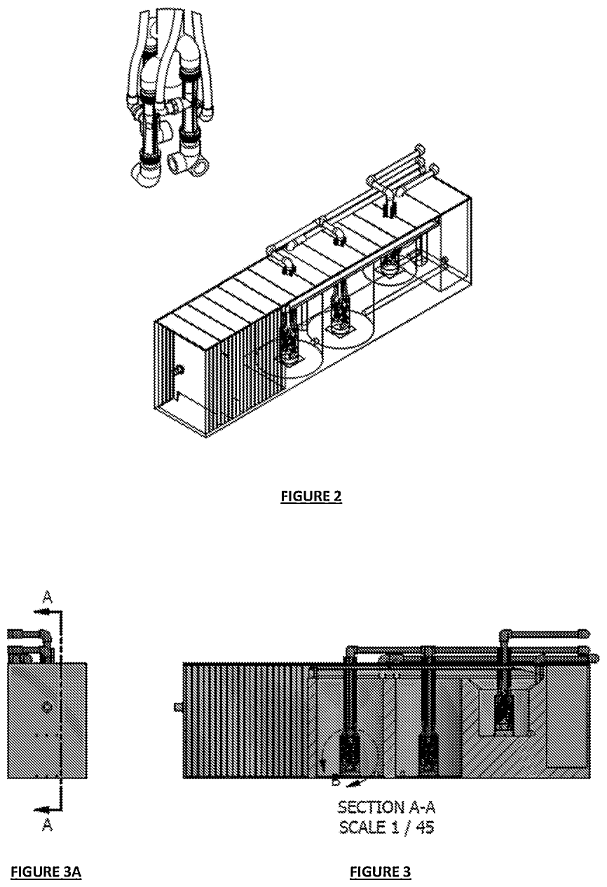

Referring to the embodiment shown in FIGS. 1 to 3, the flotation cell 10 is in the form of a thin-walled, elongate, cylindrical tank or tank, defining an interior chamber which is also circular in cross-section. The tank positioned to stand vertically upright inside a walled area of a reinforced concrete platform and the tank is largely below the water level in use. The tank itself can comprise a tube or a plurality of joined casing elements made of hard plastic or metal, sufficient to withstand the hydraulic pressure of the volume of water it is to contain, and not collapse, sag or corrode.

The chamber interior chamber has an inlet hole which is arranged to admit water feed material into the chamber nearer toward the uppermost in use side wall of the flotation cell. In the embodiments shown in the Figures, the inlet is in the form of a hole, arranged in the outer casing wall of the tank, and into which a valve closure is located. In use, the hole provides the pathway for a flow of liquid from a contaminated body of water to flow directly into the tank under the influence of the gravitational head of water, as will be described. The water flows directly into the interior chamber of the two parallel flotation tanks, and such filling will likely be done on an intermittent basis if the flotation process is to be operated in a batch mode, or if in a semi-batch mode, one chamber can be filling or discharging, while the other chamber is undergoing fractionation separation. In this way, they are arranged to operate independently of one another by being configured to admit and to discharge water using a parallel flow arrangement.

In FIGS. 1 to 3 the chamber also has a gas introduction device in the form of a plurality of elongate, axially aligned conduits which terminate at their lower end at 90 angle degree pipe bends fitted with venturi restrictors to generate air bubbles when air is fed into the foam fractionation system. The conduits are removable in the sense that they can be lifted upward and out of the centre axis region of the flotation chamber in the tank, which is itself located largely below the water line in use. By sparging from positions at around the centreline axis of the tank, and by using an external connection to a gas supply pipe located above chamber (and connected to an external source which is located nearby, and not shown) it is possible to charge large amounts of pressurised gas into the chamber. The introduced gas typically causes the water in the flotation cell to flow in a circular motion. The venturi nozzles located in the conduit outlets create very small bubbles which allow wet and stable flotation foam to be formed, which has the result of providing maximum opportunity for the interfacial collection of the contaminant material, in addition to discouraging the settling of any remaining fine particulate material in the lower region of the flotation chamber.

Each of the lowermost conduit ends have a central axis which is angled at 90 degrees to the vertical axis of the aligned conduits, which means that the air flow will exit each of the conduits in whichever direction the conduit ends are pointed. Although the conduit ends are each at slightly different depths, they are all in about the same horizontal plane, which is generally aligned with the chamber base. The conduit ends are arranged to point out from the centreline region, and toward an interior volume of the flotation chamber, but those same ends are also oriented at an angle of less than 90 angle degrees to any notional vertical plane passing through the vertical centreline of the chamber where the conduits are positioned, which means that they do not point directly at right angles towards the interior walls of the flotation chamber, but at a tangent. This adaptation results in a generally rotational or swirling flow of said introduced gas and water, with an axis of rotation aligned with an elongate axis of the chamber, said swirling flow being generally laminar along the interior peripheral wall of the chamber.

During use, gas is charged into the chamber at a pressure and flow rate that causes bubbles to form at the venturi and then, due to buoyancy, rise upward along the length of the chamber. The use of a bubble generation device in-line, like a venturi can restrict and then immediately expand the gas flow, thereby causing fine bubbles to be formed. Typically, the gas used is compressed air, but other gases can be used depending on the site requirements. For example, to oxygenate the water, the gas introduced could be oxygen and/or ozone, perhaps mixed with air.

Whichever way it is achieved, once the gas bubbles are formed they will rise in the chamber and mix with the water which has flowed into the chamber via the conduit, and filled the chamber. The bubbles will rise toward the uppermost end of the chamber within the tank, and during this residence time have had plenty of opportunity to interact with the water, and for the bubbles to come into contact with organic contaminant(s) present.

At the upper end of the chamber, the interaction of the bubbles and the organic contaminant in the water, results in the formation of a froth layer, which develops immediately above an interface located at the raised dynamic water level (DWL, or H) of water which is located within the chamber. The static water level (or Hs) rises to the dynamic water level (or H) once the flow of air is added during the treatment process. The dynamic water level can be controlled by various means, including by the design of the chamber and outlet, however the primary control is undertaken by variations in the inlet gas delivery rate, or water inflow and outflow rates. In one example, the inlet gas delivery rate can be regulated using information from a water level interface sensor which is located within the chamber, where signals from such a level sensor can be sent to a control system connected to an adjustable valve on the gas delivery line, or water inflow and outflow rates.

In the FIGS. 1 to 3, the chamber outlet is arranged to allow water to egress from the chamber nearer toward the lowermost in use end of the flotation cell. In the embodiments shown in those Figures, the chamber outlet is in the form of a hole, arranged in the outer casing wall of the tank, and into which a conduit is located, and oriented orthogonally to the elongate axis of the tank. The conduit is arranged to permit the flow of liquid therethrough in use to pass into the final adsorption stage after flotation.

The froth layer formed above interface with the dynamic water level in the chamber will rise up inside the tank and further into the uppermost end thereof. The wettest portion of the froth layer is closest to the interface which forms at the upper surface of the dynamic water level of water in the chamber, and it progressively drains and becomes drier as the froth layer rises further above the interface within the tank 16. Surface active material carried into the froth layer includes the organic contaminant. In this way, the contaminant becomes much more concentrated in the froth layer compared with its initial concentration in the feed water. The froth phase is also of considerably less volume to deal with for secondary processing, compared with the volume of feed water.

Once the drained froth layer rises up into the upper end of the tank, a froth removal device is used to remove the froth layer from the chamber. In the embodiment shown in FIG. 1, a froth removal device in the form of a suspended rectangular shaped vacuum suction hood is positioned at, an optimal distance above the dynamic water level interface with the froth layer in the two flotation tanks.

The froth rises up through the rectangular concentration hood and exits through an open outlet at the top end of the hood. The froth, which is now drier as a result of becoming drained by being confined by the somewhat tapering flow passage within the hood, then moves on to further treatment.

In the example shown in FIGS. 1 and 2, the suction hood is used to collapse the foamy froth concentrate and cause it to flow upward via a vacuum line and into a liquid concentrate receiving tank via a hose pipe assembly connected to a vacuum system operated by a pump (not shown, but located in an external building on the shoreline). This system allows the collapsed froth to be further processed. The vacuum suction in the hood is set to a minimum level sufficient to cause collapse of the drained froth layer into a liquid form. Experiments have shown that the location of the vacuum suction hood (acting as a froth depth regulation device) can control the amount of water in the froth layer, which therefore influences the concentration of the contaminant substance achieved in the froth layer.

In a further example of how to optimise the operation of the system, the inlet gas delivery rate into the chamber of the flotation tank can be regulated using information from a conductivity meter, or a water level sensor, which can be located on an interior wall of the chamber. Signals from the water level sensor can provide information about the water content of the froth layer, and can be sent to a control system connected to an adjustable valve on the inlet flotation gas delivery line. In such an example, if the froth layer is insufficiently dry, the flow of introduced gas into the chamber may need to be decreased, because there is too much water being moved in the froth layer and the process is not concentrating the contaminant sufficiently. Conversely if there is little or no production of froth, the flow of introduced gas into the chamber of the flotation tank may need to be increased.

In the present situation where the vacuum suction hood is arranged at a fixed location relative to the flotation chambers within the tanks, it is the location of the interface at the dynamic water level which is responsive to changes in the flow of the introduced gas, and/or the water inflow and outflow rates.

In operation, the flotation cell can be used to remove a substance such as an organic contaminant from the water being treated. The present disclosure is mainly concerned with the removal of an organic substance known generally as a perfluoroalkyl substance or a polyfluoroalkyl substance (PFAS). This can include one or more of the group comprising: perfluorooctane sulfonate (PFOS); perfluorooctanoic acid (PFOA); perfluoro-n-hexane sulfonic acid, (PFHxS); poly fluorinated carboxylic acids, alkyl sulfonates and alkyl sulfonamido compounds; and fluorotelemeric compounds, each having differing carbon chain lengths; and including precursors of these. The main substances of interest from this group are PFOS, PFHxS and PFOA which can persist in water for a long time.

As gas is charged into the chamber and bubbles form at the venturi outlets, the bubbles rise upward over length of the chamber and accumulate in the froth layer located above the interface which forms at the upper surface of the dynamic water level.

When the collapsed froth concentrate from the first stage of froth fractionation containing the organic contaminant(s) has been discharged into a separate liquid concentrate receiving container, or knock-out vessel, it can then subjected to a further concentration (a secondary or a hyper-concentration) flotation stage.

After secondary flotation, the final treatment of the super-concentrated foam resulting from that foam fractionation stage can simply involve drying out of the substance followed by destruction, for example off-site incineration. It is also possible to provide treatment stages to remove the concentrated organic contaminant(s), for example by absorption onto solid or semi-solid substrates (using an activated carbon, a clay, an ion exchange resin or another organic material), or by filtration (using reverse osmosis membranes to filter and increase the concentration of contaminant(s) and reduce treatment volumes). Once the absorption capacity of a substrate is exceeded it can then be regenerated or destroyed.

The secondary flotation stage concentration of the collapsed froth is undertaken using a similar process to that used for the primary separation stage, and may be conducted in a similar (or smaller) size of flotation vessel where the collapsed froth in the chamber is subject to further gas sparging and froth concentration. Multiple concentration steps may even be undertaken using this approach, to minimise the volume of fluids requiring treatment. Residual fluids (clean water) remaining after these reconcentration steps may be re-introduced to the water body or released downstream into the environment.

The system shown can operated using continuous flow or as a batch process, depending on the concentration and nature of PFAS contaminants and co-contaminants. FIGS. 1-3 illustrate two primary foam fractionation tanks, to support rapid foam generation via aeration of the water that is being treated in the tanks.

In a batch application, each foam fractionation tank is filled to a predetermined level and this batch is treated within the confines of the tank for a fixed period before it is released to the next stage of the fractionation process. Typically this approach is used where longer retention times are required.

The dense bubble stream which is produced by the venturis, and the high interfacial surface area of the bubbles provides both sufficient mixing agitation as well as a strong attraction for PFAS which may be present in solution in the feed water. The PFAS molecules are quickly scavenged from the water and drawn to the top of the water tank. The foam formed at the top of water tank is highly enriched in PFAS and by using the vacuum extraction head, the foam can be crowded and drained. Before the foam has a chance to collapse and dissolve back into the water, it is harvested by the vacuum extraction head and drawn into a centralised collection tank.

By establishing appropriate flow rates (and therefore detention times), the water travelling through the tank (now depleted in PFAS) is discharged through the outlet conduit near the tank base and then into an adsorption stage for final cleaning. Fractionated residual water flowing out from the adsorption treatment stage is directed for release to the environment.

Any of these exit or entry points on the tanks for water to flow through when a stage of processing is about to get underway or is completed, has a closure which is operable to control the flow of water into or out of the respective chamber.

PFAS concentrate/foam drawn from the primary fractionation tanks is temporarily stored in a “knock-out” vessel. This material is then further processed in the third, smaller foam fractionation tank which is especially designed for treatment of primary concentrates to create a secondary concentrate (or hyperconcentrate). Hyperconcentrate/foam removed from the third fractionation tank is directed for storage and then finally for offsite destruction. Treated water flowing in conduit from the base of the concentrate fractionation tank can be returned to the primary feed tank for reprocessing, or where appropriate it can be redirected to a liquid waste disposal/treatment system or released to the environment. Vacuum exhaust air from all fractionation tanks are directed through absorptive filters prior to release to atmosphere.

The assembled “on-water” vessel sits approximately 0.5 m above the water body or dam level, and at the outlet levy, weir or spillway of the water body to the outflow river or stream, to prevent water from circumventing the flow through the treatment process. Typically a HDPE drainage line (120 mm diameter) is needed to provide an outlet for the process flow treated water to get past the levy or weir and not allow backflow of treated waters.

The assembly comprises three main stages, and an optional fourth stage:
a pre-treatment zone—to remove solids, debris and fine sediment. As shown in FIG. 1, use has been made of a triple interceptor system with removable perforated mesh/heavy woven filter pads which can be mechanically cleaned with a gurney;
(ii) a primary flotation zone—to remove the PFAS by flotation, there are two 2,000 L single-stage aeration reaction vessels plumbed in parallel
(iii) a secondary flotation zone (or re-concentration or hyper-concentration)—where the concentrated PFAS from the primary flotation process stage is then re-floated to produce a more concentrated final product; and
(iv) an adsorbent media zone—where an absorbent surface active material can optionally be installed to act as a fail-safe/short-chain PFAS polishing stage, prior to discharge of the treated water.

The floating barge or pontoon unit can be constructed from pre-cast concrete and also fitted with a gantry across the top to allow access for servicing, including lightweight lids that pivot open to access plant and equipment, but prevent wind from blowing PFAS-rich foamate out of the flotation tanks and onto nearby environmental settings. The gantry shall be fitted with fall and edge protection and a security gate to prevent unauthorised access to over-water risk.

A structure positioned on a bank of land adjacent to the body of water (such as a small 10 ft shipping container) can be used to house system pumps and controls, as well as a large scale waste tank to receive and store the secondary concentrate (hyper-concentrate).

The proposed system shall provide treated water to meet the Australian Drinking Water Guidelines (PFAS NEMP, 2018) without any additional polishing treatment. However, drinking water guidance criteria in the US and in Europe also includes various C4, C5, and C6 short chain PFAS compounds which have ineffective/limited removal rates using foam fractionation alone. If revised Australian Drinking Water Guidelines see short-chain PFAS added to the criteria, then additional polishing can be achieved by including the adsorbent polishing treatments in the present apparatus.

Primary and then Secondary foam fractionation stages can rapidly reduce the total mass of PFAS present in a water body by using aeration to separate/concentrate PFAS substances into a froth or foam product, thus presenting less concentration of PFAS-impacted surface water remaining, for flow via the absorptive treatment device. This can result in increased longevity of the absorptive bed and/or a decreased mass resin needed.

Foam fractionation followed by absorption on resin-coated aggregate provides a passive Permeable Reactive Barrier (PRB) at the region of the surface drain. The combination represents a new passive fail-safe design at low cost to remove long, medium and short chain PFAS either when surface drains become filled due to a rain event fill, or when a water body/dam outflow situation arises. The process design can readily cope with low to medium rainfall events, and significant reduction in priority PFAS during heavy rainfall (high surface water velocities).

During periods of no-flow, the “on water” apparatus can be elevated above the waterline and deactivated and not require any personnel on-site, nor consume power. This proposed solution is not expected to interfere with other remediation treatment technologies (eg. ex-situ and in-situ groundwater treatment systems, soil containment).

The present embodiment shown in the drawings provides a Passive Remediation Trap that reduces priority PFAS (including PFOS, PFHxS & PFOA) using flow-through foam fractionation tank cells followed by resin absorption of both long and/or short chain PFAS molecules. Removal of priority PFAS via the PSDRT to below drinking water criteria is expected (ie. PFOS <0.07 μg/l, PFHxS <0.07 μg/l, PFOA <0.56 μg/l).

Foam fractionation is a proven physical separation/concentration remediation process for rapidly removing bulk PFAS and priority PFOS, PFOA and PFHxS, including high Henry's Constant co-contaminants and other foaming agents in a single step. Foam fractionation using a continuous batch process to maximise treatment conditions can effect the removal of PFOS, PFHxS and PFOA to below the Australian drinking water criteria prior to subsequent polishing treatments.

Harvested foamate (rich in PFAS) can be further fractionated to reduce water content to manage the volume of waste streams. The height or depth (m) and diameter (m) of the SAFF vessel/well provides the primary engineering factors that influence PFAS removals rates: water treatment capacity and aeration dwell time for removal of PFOS (3 mins), PFOA (3 mins) and PFHxS (12 mins) to effect complete treatment to less than drinking water criteria (PFOS, PFHxS; 0.07 μg/l) and PFOA (0.56 μg/l).

In periods of high surface water flow (ie. heavy rainfall), a reduced dwell time may result in priority PFAS (including short chains) migrating through to the next treatment step being the resin absorption stage which is located post flotation in the PSDRT.

PFAS-rich foamate in the form of an aqueous liquor may be temporarily stored in a bunded IBC for removal followed by licenced disposal by plasma incineration (with consideration for future on-site chemical oxidation cell/cold plasma cell destruction).

Absorption resin aggregate can be restrained within a geo-fabric wrapped gabion cage to withstand expected surface water flow velocities to prevent adsorbents from being washed away.

Temporary water storage devices: such as the froth flotation vessel/well shall be covered with a small gauge steel grill to keep animals and birds away/out and allow operator walking access/inspection.

Flotation residence/dwell time is affected by surface water velocity filling each of the Fill 1, 2, and 3 aeration vessel/well zones.

Surface water leaving the PSDRT shall not contain PFAS above the Australian drinking water criteria which is (ie. PFOS <0.07 μg/l, PFHxS <0.07 μg/l, PFOA <0.56 μg/l) during low and medium/high flow events. The definitions of low flow, medium flow and high flow events require agreed definition and PSDRT sizing before these important measures can become measures for success. An assessment of other PFAS signature compounds such as 6:2-FTS, 8:2-FTS, and detectable ≥C6 PFAS compounds present in surface water may indicate the need for the application of an absorption step to provide fail-safe polishing treatment.

In some embodiments, the installation of the system could be situated directly alongside of the existing surface drain to avoid installing/reinstating a temporary diversion drain during the proposed construction works. This would allow for a diversion gate to be installed into the design allowing surface drain water to either flow by gravity into the unit, or bypass it dependent upon the site needs.

Airfields and other Defence bases rely on large inter-connected surface drain networks to rapidly channel water away from runways and training grounds during wet weather. Existing interceptor pits may also provide an opportunity to remove PFAS by installing the modified foam fractionation system shown in the drawings to provide a ‘first-flush’ mechanical treatment to be gravity-fed with surface drain water to prevent perimeter drains from accumulating high level PFAS flows from impacting off-site receptors. The purpose of first-flush interception device is to rapidly reduce high concentrations of priority PFAS (including PFOS, PFHxS & PFOA) down to low levels so that secondary interception mechanisms and/or polishing treatments can operate to remove PFAS to levels below regulatory criteria for the least commercial cost in terms of $cost per kg PFAS removed per annum.

An on-water, or in-water, design offers the capability to remediate the water body and reduce the mass flux of PFAS from leaving a nearby contaminated site in a circumstance of high water flow. This design can also allow the dam capacity to be lowered in preparation for forecasted heavy rainfall events.

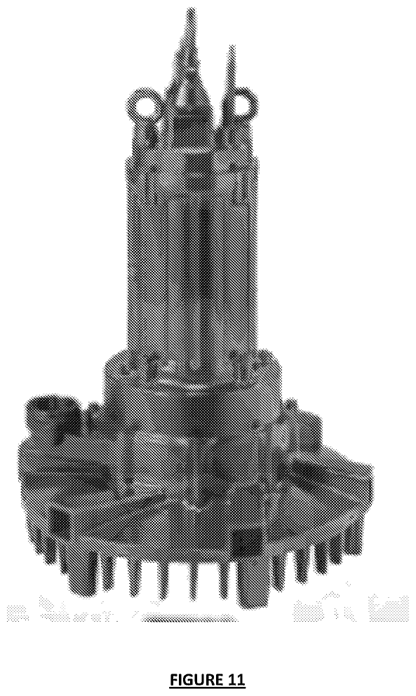

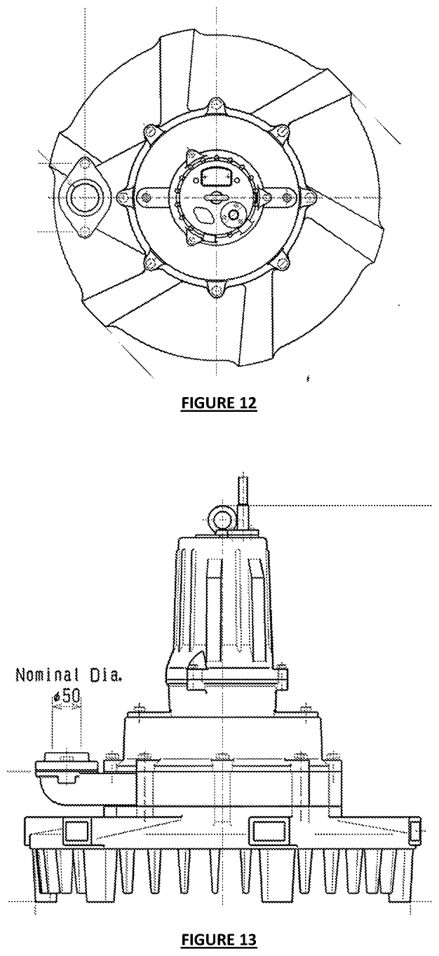

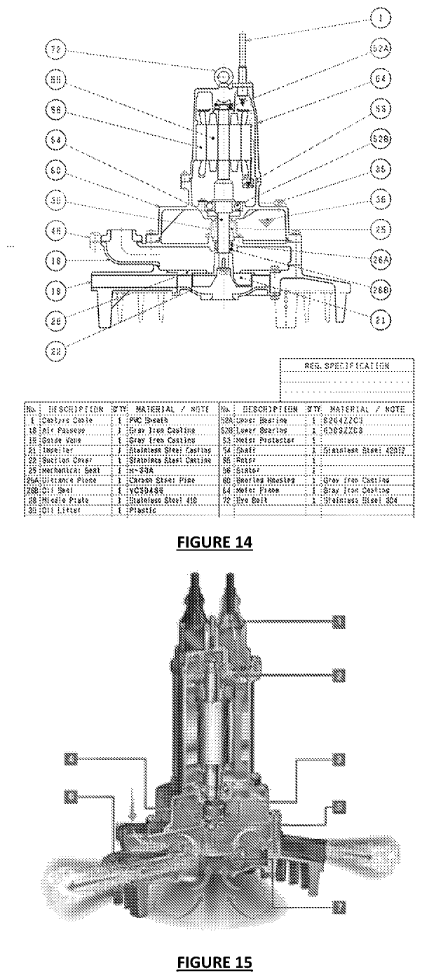

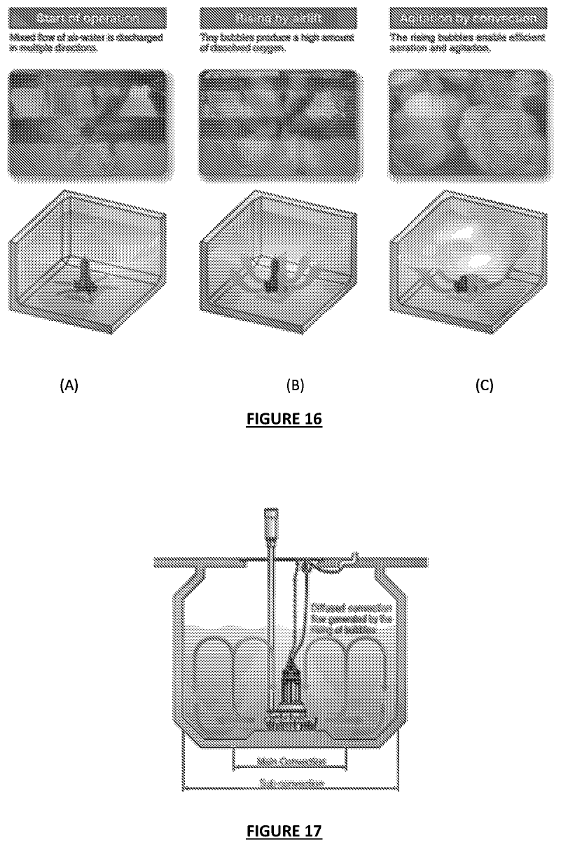

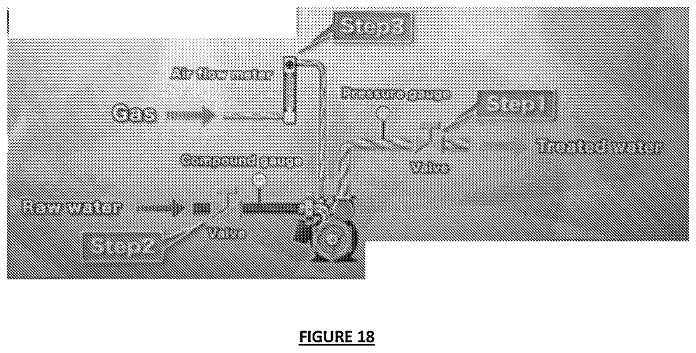

FIGS. 11 to 17 show a different type of aeration device, being a submersible aerator which is positioned in use on the floor of the flotation chamber. This device is adapted for inducing a generally rotational or swirling flow of the water and expelled gas in the chamber with an axis of rotation aligned with an elongate axis of the aerator. As shown in FIG. 17, the vertical axis of the aerator is approximately aligned in use with a central, vertical axis of a respective flotation chamber, but that need not always be the case, and the submersible aerator can be readily located in many positions, and indeed the exemplary flotation cell chambers shown in this specification are only some examples of the many shapes of vessel possible to use.

These aerators produce bubbles in the water by mixing the air or other gas drawn from above the surface of the water. The gas being received by the device is drawn thereinto by generating a negative pressure (or suction pressure) behind the impeller paddles as the impeller is mechanically rotated. Water from the chamber also flows into the impeller zone to replace the water which is being expelled by the rotating impeller.

The rotation of the impeller also discharges the aerated water into the interior volume of the chamber, combining the steps of aeration and agitation. Because this is a mechanically rotatable device, the impeller rotates unidirectionally in response to the movement of a rotating drive shaft. In the embodiment shown, there are equally spaced pumping blades on the impeller, and evenly spaced-apart exit guide vanes arranged circumferentially around the impeller zone, so the aerated flow exiting the impeller zone is equally discharged in all directions, into the central interior volume of the chamber (see FIG. 15). The synergistic effect of the airlift and convection that this mechanism gives rise to the swirling flow motion in the tank (as shown in FIG. 16 and FIG. 17).

The presence of the guide vanes causes said water and bubbles of gas to be expelled in a plurality of flowstreams which are directed to flow tangentially (or at an angle) to the perimeter of the submersible aerator (say between 25-45 angle degrees to a plane passing through the centre of the aerator), causing the swirling motion. Importantly, this means that the flow exiting the impeller is not directed at perpendicularly (at 90 angle degrees) outwardly from the aeration device and toward the interior wall of the flotation chamber, which would create turbulence, and which can in turn destabilise a delicate froth bed being produced at the interfacial surface at the upper end of the foam fractionation chamber. instead of a stable froth bed, which can form when the fluid in the chamber is moving in a smooth rotational or swirling motion, therebeneath.

The gas inlet to the submersible aerator can be via a conduit hose or flexible pipe which extends down into the tank from a source above the surface of the water, to reach the inlet port on the aerator (see FIG. 13) which is positioned on the bottom floor or base surface of the interior chamber of the froth fractionation tank. In other embodiments, there can be more than one gas inlet flow pipe or flow line arranged about an axial centreline of the chamber, or the aerator can even be connected to a chamber wall or base floor mounted port, to access the inlet air/gas, and enable more efficient aeration and agitation,

Such aerators are built to draw air by themselves while submerged in water, so they can aerate and agitate without requiring a gas blower, which greatly reduces both installation space and noise, as well as operating costs. In such cases, the gas received by the gas introduction device is usually air from the external atmosphere.

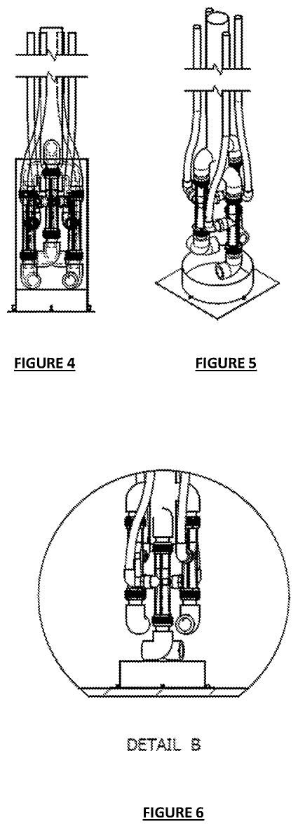

The use of a submersible pump or aerator with aeration vanes that sits on bottom of a water filled flotation chamber also is a lower construction cost option as well as lower maintenance option, compared with say the top-mounted venturi version shown in FIG. 4.

Generally, water bubbles can be categorized into three major types, i.e., ordinary or macrobubbles, microbubbles (MBs), and nanobubbles (NBs). The diameter of macro-bubbles ranges from 100 μm to 2 mm. These bubbles quickly rise to the surface of a liquid and collapse. While microbubbles are smaller than macro-bubbles, with a diameter range of 1 μm-100 μm, these bubbles may shrink in the water and then dissolve into it. NBs are extremely small gas bubbles that have several unique physical properties that make them very different from normal bubbles. Generally, NBs range <1 μm in diameter have a lower buoyancy can remain suspended in liquids for an extended period of time and have the ability to change the typical characteristics of water.

Micro- and nanobubble (MNB) technology and its application for wastewater treatment has emerged as a useful technology to be used in water treatment. Concerning organic substances, i.e., dissolved and organic carbon and aliphatic or aromatic mixtures, MBs have been shown to increase the hydrophobicity of surface particles leading to enhanced efficiency of flotation. The use of MNB in water treatment has great potential because of their distinctive properties such as higher mass transfer rate, collision efficiency, lower rising velocity, customized surface charge, and radical generation give MNBs a more promising role in future techniques of water treatment such as disinfection and flotation.

In the present apparatus, the gas introduction device additionally comprises an aerator in the form of a microbubble or nanobubble generator arranged to be in fluid communication with the water admitted into the chamber.

In some embodiments, the microbubble or nanobubble generator is arranged in use to receive gas from outside the chamber, and to generate microbubbles or nanobubbles in a flow stream of water which is continuously removed from and returned to the chamber. In some alternative embodiments, the microbubble or nanobubble generator is arranged in use to receive gas from outside the chamber, and to generate microbubbles or nanobubbles in a flow stream of water which is intermittently removed from and/or returned into the chamber, in a sort of pulsed air delivery.

The expected benefits in terms of impact and/or reduced cost of the application of the method and equipment disclosed herein can be summarised as follows:
A secondary benefit is providing a community expected solution that keeps PFAS impacted surface water on-site without creating a hydraulic dam that puts airfields and bases at flood risk during wet weather. The cost saving is expected to be significant.
Froth flotation is expected to remove all PFOS and PFHxS to less than drinking water criteria (0.07 μg/l) and PFOA (to less than 0.56 μg/l) under normal rainfall events, including:
   Removal of high Henry's Constant co-contaminates, and other foaming agents in a single step without chemical treatments,
   Minimal supervision/maintenance by site operator. The system can be maintained in standby mode until significant weather events are forecast to create surface water migration within surface drain networks,
   Complements existing site infrastructure (drainage network and surface drains that move surface water from airfields, buildings and telecommunication structures), and
   Provides a fail-safe design where both froth flotation and absorption stages are capable of passively removing PFAS from surface waters during rainfall events. This is because the froth flotation stage and the following absorption are considered to be Permeable Reactive Barriers (PRB's) (e.g. air is the PRB separation medium, and coated aggregate is the PRB adsorption medium).
   The design can allow for installation at any other site where surface drains are subject to rainfall surface water flows that are impacted by PFAS from source zone soils during migration.
   Placement of froth flotation separation an in-ground situation but where surface water is disconnected from the engineering well/chamber design allows gravity to collect the water within the well. Aeration is triggered by sensor to initiate removal/concentration of PFAS.
   sediment/solids fouling of the flotation chambers and of the volumetric spaces between the aggregate particles of the absorption stage can be minimised by the use of a prior sedimentation stage or a settling tank stage located in the concrete bunded causeway zone of the PSDRT.
   Residence times of the contaminated water in the flotation stage is expected to be at least 3 mins to remove PFOS/PFOA and 12 mins for PFHxS, with greater than 35 mins to reduce C4 to C6 fluorinated molecules, noting PFBA/PFPeA expected to be non-responsive.
   The process design assumes that the mass of the geo-fabric wrapped gabion cage containing the aggregate (12 mm to 20 mm blue metal gravel) which is coated with the active resin material will not be washed away during heavy/flood events.
   Froth flotation and resin absorption are considered passive permeable reactive barriers. The froth flotation relies on the air/water thin layer surface/boundary as the reactive barrier and the resin absorption relies on water passing through the proprietary adsorbent material as the reactive barrier.

### EXPERIMENTAL RESULTS

Experimental results have been produced by the inventors using both laboratory (batch) and a pilot-scale (continuous) configuration of the new apparatus and method disclosed herein, to observe any beneficial outcomes during the operation of the process of concentrating PFAS from groundwater samples.

(1) The Inventors have Discovered that Certain Specific PFAS can be Treated by this Technique

| | | |
|---|---|---|
| | | Level of Concern |
| Compound Name | Abbreviation | (Priority/Secondary/Other) |

Successfully Removed by Foam Fractionation
(to either below drinking water criteria or below level of reporting)

| | | |
|---|---|---|
| Perfluorohexane sulfonic acid | PFHxS | Priority |
| Perfluorooctane sulfonic acid | PFOS | Priority |
| Perfluorooctanoic acid | PFOA | Secondary |
| Perfluorononanoic Acid | PFNA | Other |
| Perfuorodecanoic Acid | PFDA/Ndfda | Other |
| 6:2 Fluorotelomer Sulfonate | 6:2 FTS | Other |
| 8:2 Fluorotelomer Sulfonate | 8:2 FTS | Other |

Moderately Reduced by Foam Fractionation

| | | |
|---|---|---|
| Perfluoroheptanoic Acid | PFHpA | Other |

Little effect by Foam Fractionation

| | | |
|---|---|---|
| Perfluorohexanoic acid | PFHxA | Secondary |
| perfluorobutane sulfonic acid | PFBS | Secondary |
| perfluoropentane sulfonic acid | PFPeS | Secondary |

Both of the key priority PFAS compounds of concern (PFOS and PHFxS) can be successfully removed by Foam Fractionation (FF). FF was also found to be similarly effective in physically removing PFOA (a secondary priority compound) and four other routinely analysed PFAS compounds. Perfluoroheptanoic Acid (PFHPA) was moderately reduced by FF. The three other secondary priority compounds (PFHxA, PFBS and PFPeS) were shown to be minimally, or not affected by FF, and thus can be separated from the primary priority compounds using the foam separation which has been developed.

In summary, FF is ideally suited to physically removing the priority PFAS molecules (including other theoretical non-PFAS co-contaminates) allowing more sophisticated (and expensive) techniques to be reserved as polishing treatments to achieve concentrations below criteria for regulated disposal or discharge.

From the above, it will be understood that at least some embodiments of apparatus and method in accordance with the present inventions provide one or more of the following advantages, in comparison to conventional treatment methods:
A lower volume of PFAS concentrated liquor is produced for the secondary absorption treatment step;
A smaller secondary treatment plant is required;
A lower overall treatment time is achieved compared to standard “pump and treat” systems;
A smaller volume of concentrated liquor means that use of a complete destruction process (not disposal to landfill) is feasible;
Has the ability to extract contaminant from water pumped out of contaminated ground instead of performing in-situ chemical treatment, which may not work (or be reversible), and may not reach all levels of groundwater contamination.
The system can be expanded easily to meet specific site requirements as the fractionation tanks, pumps, vacuum systems, pipework and connections are comprised of standard componentry, expansion is simply a matter of replicating systems in parallel, and pump and blower sizes may be adjusted (up or down) to meet the changed requirements.
A physical separation process located in the ground but not in actual physical contact with the water table avoids the use of potentially hazardous chemicals as part of in-situ chemical treatment approaches, and produces no by-products or wastes.

Throughout this specification, the words “froth” and “foam” may be used interchangeably but are taken to mean the same thing, essentially comprising a wet liquid concentrate having low quantities of particulate materials or concentrated organic contaminants, and extracted by various designs of devices which aim to provide as much control and reduction of the water content in the froth layer as possible.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “upper” and lower”, “above” and “below” and the like are used as words of convenience to provide reference points and are not to be construed as limiting terms.

The reference in this specification to any prior publication or information is not, and should not be taken as, an acknowledgement or admission or any form of suggestion that the prior publication or information forms part of the common general knowledge in the field of endeavor to which this specification relates.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A method of separating an amount of a substance from water which is contaminated with the substance, the method comprising the steps of:
admitting an amount of the water, which includes an initial concentration of the substance, into a chamber via an inlet thereinto;
introducing a flow of gas into the chamber, wherein said introduced gas induces the water in the chamber to flow, and produce a froth layer which is formed at, and which rises above, an interface with the said flow of water and of introduced gas in the chamber, the froth layer including an amount of water and also a concentrated amount of the substance when compared with its initial concentration;
removing at least some of the froth layer from an upper portion of the chamber; and then
passing a flow of the water from the chamber through an absorptive treatment device which is arranged to remove therefrom a further amount of the substance not already removed in the froth layer.

2. A method as claimed in claim 1, wherein the flow of gas and the production of the froth layer is continuous.

3. A method as claimed in claim 1 or claim 2, further comprising the step of controlling the water content of the froth layer which rises above the interface to influence the concentration of the substance therein.

4. A method as claimed in claim 3, wherein the step of controlling the water content of the froth layer is by of the group comprising: controlling a physical parameter of the flow of introduced gas; and controlling a physical parameter of the froth layer.

5. A method as claimed in claim 4, wherein the step of controlling a physical parameter of the flow of introduced gas comprises use of a flow controller and an inlet valve for controlling the flow of said introduced gas into the chamber.

6. A method as claimed in claim 4 or claim 5, wherein the step of controlling a physical parameter of the froth layer comprises the use of a froth depth regulation device for maintaining a depth of the froth layer above the interface.

7. A method as claimed in any one of claim 4 to claim 6, wherein the step of controlling a physical parameter of the froth layer further comprises use of a device for confining the cross-sectional flow path of the froth in the upper portion of the chamber, resulting in drainage of said froth layer.

8. A method as claimed in any one of the preceding claims, wherein the froth layer is collapsed during said removal step from the upper portion of the or each chamber, prior to undergoing a secondary treatment step.

9. A method as claimed in claim 8, further including the steps of:
passing the collapsed froth layer including the concentrated substance into a further chamber, said further chamber having a gas introduction device which in use admits gas thereinto, the introduced gas for inducing flow within the further chamber, and for producing a further froth layer which is formed at, and which rises above an interface with the said flow of the collapsed froth layer and introduced gas in the further chamber, the further froth layer including an amount of water and also a more concentrated amount of the substance when compared with its concentration in the collapsed froth layer, and
removing at least some of the further froth layer from an upper portion of the respective further chamber;
whereupon a remaining portion of the collapsed froth layer in the further chamber is passed through the absorptive treatment device.

10. A method as claimed in claim 8, wherein the secondary treatment step for treating the collapsed froth layer including the concentrated substance uses at least one of the processes of the group comprising: absorption (using an activated carbon, a clay, or an ion exchange resin), filtration (using reverse osmosis membranes).

11. A method as claimed in any one of the preceding claims, wherein the substance is at least one of a perfluoroalkyl substance or a polyfluoroalkyl substance (PFAS).

12. A method as claimed in claim 11 wherein the perfluoroalkyl or polyfluoroalkyl substance (PFAS) includes one or more of the group comprising: perfluoro-octane sulfonate (PFOS); perfluoro-octanoic acid (PFOA); perfluoro-n-hexane sulfonic acid, (PFHxS); perfluorononanoic acid (PFNA); perfluorodecanoic acid (PFDA/Ndfda); 6:2-fluorotelomer sulphonate compounds (6:2 FTS); 8:2-fluorotelomer sulphonate compounds (8:2 FTS); and perfluoro-octanoic acid (PFHpA).

13. A method as claimed in any one of the preceding claims, further including the step of pre-selecting an absorptive solid material for the absorptive treatment device.

14. A method as claimed in claim 13, wherein the pre-selected absorptive solid material is a composite particle comprising an aggregate core which is surface-coated with a reactive absorbent material.

15. A method as claimed in claim 14, wherein the adsorptive solid material is housed in a permeable reactive barrier (PRB).

16. A method as claimed in any one of claim 13 to claim 15, wherein the preselected absorptive solid material is suitable for absorption of one or more perfluoroalkyl or polyfluoroalkyl substances (PFAS) from the group comprising: perfluoro-octane sulfonate (PFOS); perfluoro-octanoic acid (PFOA); perfluoro-n-hexane sulfonic acid, (PFHxS); perfluorononanoic acid (PFNA); perfluorodecanoic acid (PFDA/Ndfda); 6:2-fluorotelomer sulphonate compounds (6:2 FTS); 8:2-fluorotelomer sulphonate compounds (8:2 FTS); and perfluoro-octanoic acid (PFHpA).

17. A method as claimed in any one of claim 13 to claim 16, wherein the preselected absorptive solid material is suitable for absorption of one or more perfluoroalkyl or polyfluoroalkyl substances (PFAS) from the group comprising: perfluoro-hexanoic acid (PFHxA); perfluoro-butane sulfonic acid, (PFBS); and perfluoro-pentane sulfonic acid (PFBeS).

18. A method as claimed in any one of the preceding claims further comprising the step of removing solid material from the water prior to it flowing into the chamber.

19. A method as claimed in claim 18, wherein the step of removing solid material is by a process of at least one of the group comprising: sedimentation and screening.

20. A method as claimed in any one of the preceding claims wherein said liquid flows through the or each chamber and the absorptive treatment device passively under the influence of gravity.

21. A method of separating an amount of a substance from water which is contaminated with the substance, the method comprising the steps of:
admitting said water, which includes an initial concentration of the substance, to move under the influence of gravity into a chamber via an inlet thereinto, until the chamber is filled to a pre-determined extent; and then
introducing a flow of gas into the chamber, wherein said introduced gas induces the water in the chamber to flow, and produce a froth layer which is formed at, and which rises above, an interface with the said flow of water and of introduced gas in the chamber, the froth layer including an amount of water and also a concentrated amount of the substance when compared with its initial concentration;
removing at least some of the froth layer from an upper portion of the chamber; and then
allowing water remaining in the chamber to be discharged by flowing out of the chamber via an exit therefrom.

22. A method as claimed in claim 21, further comprising the step of passing said flow of water discharged from the chamber through an absorptive treatment device which is arranged to remove therefrom a further amount of the substance not already removed in the froth layer.

23. A method as claimed in claim 22, wherein said flow of water discharged from the chamber passes through the absorptive treatment device passively, and in response to the influence of gravity.

24. A method as claimed in any one of claim 21 to claim 23, wherein the steps of the method are as claimed in any one of claim 2 to claim 19.

25. Apparatus for separating an amount of a substance from water which is contaminated with an initial concentration of the substance, the apparatus comprising one or more chambers which:
are arranged in use to admit the movement of said contaminated water under the influence of gravity via an inlet thereinto, until the chamber is filled to a pre-determined extent;
have a respective gas introduction device, in use the introduced gas for inducing the water in the chamber to flow, and for producing a froth layer which is formed at, and which rises above an interface with the said flow of water and introduced gas in the chamber, the froth layer including an amount of water and also a concentrated amount of the substance when compared with its initial concentration;
have a device in use for removing at least some of the froth layer from a respective upper portion thereof; and
have an exit, in use to allow a discharge flow of remaining water therefrom.

26. Apparatus as claimed in claim 25 in which an absorptive treatment device is placed in fluid communication with said exit from the chamber(s), being arranged in use to receive said discharge flow of the water therefrom, and to remove a further amount of the substance from that water not already removed in the froth layer.

27. Apparatus as claimed in claim 26, wherein the flow of water from the chamber exit through the absorptive treatment device is passive, in response to the influence of gravity.

28. Apparatus as claimed in any one of claim 25 to claim 27, wherein if two or more chambers are present, they are arranged to operate independently of one another by being configured to admit and to discharge water using a parallel flow arrangement.

29. Apparatus as claimed in any one of claim 25 to claim 28, wherein the or each chamber is an elongate cylindrical vessel having an inlet comprising an opening in an upper portion of an external side wall thereof, said opening having a closure which is operable to control the admission of said contaminated water into the chamber from an adjacent body of said water.

30. Apparatus as claimed in any one of claim 25 to claim 29, wherein the or each chamber has an exit comprising an opening in a lower portion of an external side wall thereof, said opening having a closure which is operable to control the discharge of said remaining water from the chamber.

31. Apparatus as claimed in any one of claim 25 to claim 30, wherein control of the water content of the froth layer comprises apparatus for at least one of: controlling a physical parameter of the flow of introduced gas; and controlling a physical parameter of the froth layer.

32. Apparatus as claimed in claim 31 for control of a physical parameter of the flow of introduced gas into the chamber comprises the use of a flow controller and an inlet valve on a gas delivery line, responsive to a measurement of one of the group comprising: water content of the froth layer; froth stability of the froth layer; location of the interface in the chamber.

33. Apparatus as claimed in claim 32 for control of a physical parameter of the froth layer, comprises the use of a froth depth regulation device for maintaining a depth of the froth layer above the interface, wherein the froth depth regulation device is selected from the group comprising: a device which is moveably positionable within the chamber in response to movement of the location of the interface; and a device which is arranged at a fixed location in relation to the chamber, and the location of the interface is responsive to at least one of the flow of the introduced gas, and an inlet flow of the water.

34. Apparatus as claimed in claim 33, wherein the froth depth regulation device is arranged for confining the cross-sectional flow path of the froth as it is leaving the chamber, resulting in froth confinement and drainage of said froth layer.

35. Apparatus as claimed in any one of claim 25 to claim 34, comprising a froth layer removal device in which at least some of the froth layer is collapsed during removal of at least some of the froth layer from the uppermost region of the chamber, and prior to a secondary treatment step.

36. Apparatus as claimed in claim 35, wherein the froth layer collapse device includes mechanical apparatus from the group comprising: a foam breaker, a vacuum extraction device, and a froth extraction head.

37. Apparatus as claimed in any one of claim 25 to claim 36, also comprising a further foam fractionation chamber being in fluid communication with the or each of said chamber(s) in use, the further chamber arranged to:
admit thereinto the collapsed froth layer including the concentrated substance, until the chamber is filled to a pre-determined extent,
have a gas introduction device which in use admits gas thereinto, the introduced gas for inducing flow within the chamber, and for producing a further froth layer which is formed at, and which rises above an interface with the said flow of the collapsed froth layer and introduced gas in the further chamber, the further froth layer including an amount of water and also a more concentrated amount of the substance when compared with its concentration in the collapsed froth layer;
have a device in use for removing at least some of the further froth layer from an upper portion of the further chamber; and
have an exit, in use to allow a flow of remaining collapsed froth layer to be discharged therefrom.

38. Apparatus as claimed in claim 37 in which an absorptive treatment device is placed in fluid communication with said exit from the further chamber, being arranged in use to receive said discharge flow of the remaining water therefrom, and to remove a further amount of the substance from that water not already removed in the further froth layer.

39. Apparatus as claimed in any one of claim 25 to claim 38, wherein said absorptive treatment device includes the use of an absorptive solid material.

40. Apparatus as claimed in claim 39, wherein wherein the absorptive solid material is a composite particle comprising an aggregate core which is surface-coated with a reactive absorbent material.

41. Apparatus as claimed in claim 39 or claim 40, wherein the adsorptive solid material is housed in a permeable reactive barrier (PRB).

42. Apparatus as claimed in any one of claim 39 to claim 41, wherein the absorptive solid material is from the group comprising: an activated carbon, a clay, or an ion exchange resin.

43. Apparatus as claimed in any one of claim 25 to claim 42, further comprising another secondary treatment device in use for treating the collapsed froth layer for removal of the concentrated substance, wherein the treatment device includes at least one of the group comprising: filtration (using reverse osmosis membranes); vacuum distillation; drum drying.

44. Apparatus as claimed in any one of claim 39 to claim 42, wherein the absorptive solid material is suitable for absorption of one or more perfluoroalkyl or polyfluoroalkyl substances (PFAS) from the group comprising: perfluoro-octane sulfonate (PFOS); perfluoro-octanoic acid (PFOA); perfluoro-n-hexane sulfonic acid, (PFHxS); perfluorononanoic acid (PFNA); perfluorodecanoic acid (PFDA/Ndfda); 6:2-fluorotelomer sulphonate compounds (6:2 FTS); 8:2-fluorotelomer sulphonate compounds (8:2 FTS); and perfluoro-octanoic acid (PFHpA).

45. Apparatus as claimed in any one of claim 39 to claim 42, wherein the absorptive solid material is suitable for absorption of one or more perfluoroalkyl or polyfluoroalkyl substances (PFAS) from the group comprising: perfluoro-hexanoic acid (PFHxA); perfluoro-butane sulfonic acid, (PFBS); and perfluoro-pentane sulfonic acid (PFBeS).

46. Apparatus as claimed in any one of claim 25 to claim 45, wherein the gas introduction device comprises a submersible aerator which, in use, is arranged to be at least partially submerged in the water admitted into the chamber.

47. Apparatus as claimed in claim 46, wherein the submersible aerator is arranged in use to receive gas from outside the chamber, and to expel said gas into the water admitted into the chamber.

48. Apparatus as claimed in claim 47, wherein the submersible aerator is adapted for inducing a generally rotational or swirling flow of the water and expelled gas in the chamber with an axis of rotation aligned with an elongate axis of the aerator,

49. Apparatus as claimed in claim 48, wherein the vertical axis of the aerator is approximately aligned in use with a central, vertical axis of a respective chamber.

50. Apparatus as claimed in claim 49, wherein the rotational or swirling flow of the water has a generally laminar flow pattern as it moves about an interior peripheral wall of the chamber.

51. Apparatus as claimed in any one of claim 47 to claim 50, wherein as the gas is expelled from the aerator in use, it is dispersed into the water in the chamber in the form of bubbles.

52. Apparatus as claimed in any one of claim 47 to claim 51, wherein the submersible aerator comprises a plurality of elongate, vertically axially oriented conduits, generally aligned with one another over their major lengths, and arranged to extend into an interior of the chamber, for receiving and expelling the gas into the chamber in use.

53. Apparatus as claimed in claim 52, wherein an end portion of each conduit has a central axis which is angled at 90 degrees to the vertical axis of the major length of each conduit, said end portion lying in a notional horizontal plane.

54. Apparatus as claimed in claim 52 or claim 53, wherein an end portion of each conduit has a central axis which is oriented at an angle of less than 90 angle degrees with respect to a notional vertical plane passing through the vertical axis of the respective major length.

55. Apparatus as claimed in claim 54, wherein an end portion of each conduit has a central axis which is oriented at an angle of less than 45 angle degrees with respect to a notional vertical plane passing through the vertical axis of the respective major length.

56. Apparatus as claimed in claim 54 or claim 55, wherein an end portion of each conduit has a central axis which is oriented at an angle of more than 25 angle degrees with respect to a notional vertical plane passing through the vertical axis of the respective major length.

57. Apparatus as claimed in any one of claim 53 to claim 56, wherein the end portion of each conduit is fitted with an internal venturi nozzle so that in use, as gas flows via the elongate conduit and is expelled via the end portion, a dispersion of bubbles is created.

58. Apparatus as claimed in any one of claim 47 to claim 51, wherein the submersible aerator comprises an impeller zone in which is located a rotatable impeller having a series of pumping vanes, along with a series of fluid exit guide vanes positioned around the circumference of the impeller zone, such that when operably rotated in use, the aerator:
draws in gas from outside the impeller zone by generating a negative pressure behind the impeller blades, and
draws a flow of the contaminated water into the impeller zone from the chamber and subsequently expels that flow of water back into the chamber,
wherein the gas drawn into the impeller zone becomes intimately mixed with the flow of water therein, under the mechanical force of the impeller pumping vanes and exit guide vanes, to create a dispersion of bubbles in that flow of water.

59. Apparatus as claimed in claim 58, wherein the submersible aerator comprises an elongate conduit arranged to extend from outside the chamber to the impeller zone, through which the gas is drawn into the impeller zone in use.

60. Apparatus as claimed in claim 59, wherein the submersible aerator comprises a plurality of fluid exit guide vanes, arranged to guide the flow of the water with dispersed gas therein, as it is expelled into the chamber interior.

61. Apparatus as claimed in claim 60, wherein the exit guide vanes have a central axis which is angled at 90 degrees to the vertical axis of rotation of the impeller, and lie in a notional horizontal plane.

62. Apparatus as claimed in claim 60 or claim 61, wherein the exit guide vanes have a central axis which is oriented at an angle of less than 90 angle degrees with respect to a notional vertical plane passing through the vertical axis of rotation of the impeller.

63. Apparatus as claimed in claim 62, wherein the exit guide vanes have a central axis which is oriented at an angle of less than 45 angle degrees with respect to a notional vertical plane passing through the vertical axis of rotation of the impeller.

64. Apparatus as claimed in claim 62 or claim 63, wherein the exit guide vanes have a central axis which is oriented at an angle of more than 25 angle degrees with respect to a notional vertical plane passing through the vertical axis of rotation of the impeller.

65. Apparatus as claimed in any one of claim 46 to claim 64, wherein the gas introduction device additionally comprises an aerator in the form of a microbubble or nanobubble generator arranged to be in fluid communication with the water admitted into the chamber.

66. Apparatus as claimed in claim 65, wherein the microbubble or nanobubble generator is arranged in use to receive gas from outside the chamber, and to generate microbubbles or nanobubbles in a flow stream of water which is continuously removed from and returned to the chamber.

67. Apparatus as claimed in claim 65, wherein the microbubble or nanobubble generator is arranged in use to receive gas from outside the chamber, and to generate microbubbles or nanobubbles in a flow stream of water which is intermittently removed from and/or returned into the chamber.

68. Apparatus for separating an amount of a substance from water which is contaminated with an initial concentration of the substance, the apparatus comprising one or more chambers which:
are arranged in use to admit the movement of said contaminated water via an inlet thereinto, until the chamber is filled to a pre-determined extent;
have a respective gas introduction device, in use the introduced gas for inducing the water in the chamber to flow, and for producing a froth layer which is formed at, and which rises above an interface with the said flow of water and introduced gas in the chamber, the froth layer including an amount of water and also a concentrated amount of the substance when compared with its initial concentration;
have a device in use for removing at least some of the froth layer from a respective upper portion thereof; and
have an exit arranged in use to allow a discharge flow of remaining water to pass from the chamber and be received by an absorptive treatment device which is arranged to remove therefrom a further amount of the substance not already removed in the froth layer.

69. Apparatus for separating an amount of a substance from water as claimed in claim 68, wherein the or each chamber arranged in use to admit the movement of said contaminated water under the influence of gravity via the inlet thereinto, until the chamber is filled to the pre-determined extent.

70. Apparatus for separating an amount of a substance from water as claimed in claim 68 or claim 69, further comprising the features as claimed in any one of claim 27 to claim 67.

71. A method of separating an amount of a substance from water which is contaminated with the substance, the method comprising the steps of:
admitting an amount of the water, which includes an initial concentration of the substance, into a chamber via an inlet thereinto;
introducing a flow of gas into the chamber, wherein said introduced gas induces the water in the chamber to flow, and produce a froth layer which is formed at, and which rises above, an interface with the said flow of water and of introduced gas in the chamber, the froth layer including an amount of water and also a concentrated amount of the substance when compared with its initial concentration;
removing at least some of the froth layer from an upper portion of the chamber; and then
allowing water remaining in the chamber to be discharged by flowing out of the chamber via an exit therefrom.

72. A method as claimed in claim 71, further comprising the step of passing said flow of water discharged from the chamber through an absorptive treatment device which is arranged to remove therefrom a further amount of the substance not already removed in the froth layer.

73. A method as claimed in claim 72, wherein said flow of water discharged from the chamber passes through the absorptive treatment device passively, and in response to the influence of gravity.

74. A method as claimed in any one of claim 71 to claim 73, wherein the steps of the method are as claimed in any one of claim 2 to claim 19.

75. Apparatus for separating an amount of a substance from water which is contaminated with an initial concentration of the substance, the apparatus comprising one or more chambers which:
are arranged in use to admit the movement of said contaminated water via an inlet thereinto, until the chamber is filled to a pre-determined extent;
have a respective gas introduction device, in use the introduced gas for inducing the water in the chamber to flow, and for producing a froth layer which is formed at, and which rises above an interface with the said flow of water and introduced gas in the chamber, the froth layer including an amount of water and also a concentrated amount of the substance when compared with its initial concentration;
have a device in use for removing at least some of the froth layer from a respective upper portion thereof; and
have an exit, in use to allow a discharge flow of remaining water therefrom.

76. Apparatus for separating an amount of a substance from water as claimed in claim 75, wherein the or each chamber arranged in use to admit the movement of said contaminated water under the influence of gravity via the inlet thereinto, until the chamber is filled to the pre-determined extent.

77. Apparatus for separating an amount of a substance from water as claimed in claim 75 or claim 76, further comprising the features as claimed in any one of claim 27 to claim 70.

78. A method of separating an amount of a substance from water which is contaminated with the substance, the method comprising the steps of:
admitting an amount of the water, which includes an initial concentration of the substance, into a chamber via an inlet thereinto;
introducing a flow of gas into the chamber, wherein said introduced gas induces the water in the chamber to flow, and produce a froth layer which is formed at, and which rises above, an interface with the said flow of water and of introduced gas in the chamber, the froth layer including an amount of water and also a concentrated amount of the substance when compared with its initial concentration;
removing at least some of the froth layer from an upper portion of the chamber such that during said removal step the froth layer collapses, prior to it undergoing a secondary treatment step which uses at least one of the processes of absorption or filtration to remove said concentrated substance from the water, and
allowing water remaining in the chamber to be discharged by flowing out of the chamber via an exit therefrom.

79. A method as claimed in claim 78, wherein the secondary treatment step of absorption uses a pre-selected absorptive solid material.

80. A method as claimed in claim 79, wherein the pre-selected absorptive solid material is at least one from the group comprising: an activated carbon, a clay, and an ion exchange resin.

81. A method as claimed in claim 79, wherein the pre-selected absorptive solid material is a composite particle comprising an aggregate core which is surface-coated with a reactive absorbent material.

82. A method as claimed in claim 78, wherein the secondary treatment step of filtration uses a reverse osmosis membrane.

83. A method as claimed in claim 78, further comprising the step of passing said flow of water discharged from the chamber through an absorptive treatment device which is arranged to remove therefrom a further amount of the substance not already removed in the froth layer.

84. A method as claimed in claim 83, wherein the absorptive treatment device comprises a pre-selected absorptive solid material.

85. A method as claimed in any one of claims 78 to 84, wherein the substance is organic.

86. A method as claimed in any one of claims 78 to 85, wherein the substance is an amphiphilic substance.

87. A method as claimed in any one of claims 78 to 86, wherein the substance is at least one of a perfluoroalkyl substance or a polyfluoroalkyl substance (PFAS).

88. A method as claimed in claim 87, wherein the PFAS includes one or more of the group comprising the following substances:
perfluoro-octane sulfonate (PFOS); perfluoro-octanoic acid (PFOA); perfluoro-n-hexane sulfonic acid (PFHxS); perfluoro-nonanoic acid (PFNA); perfluoro-decanoic acid (PFDA/Ndfda); 6:2-fluorotelomer sulphonate compounds (6:2 FTS); 8:2-fluorotelomer sulphonate compounds (8:2 FTS); and perfluoro-octanoic acid (PFHpA); poly fluorinated carboxylic acids, alkyl sulfonates and alkyl sulfonamido compounds; and fluorotelemeric compounds, each having differing carbon chain lengths; and including precursors of these.

89. A method as claimed in any one of claims 79 to 81, or claim 84, wherein the preselected absorptive solid material is suitable for absorption of one or more perfluoroalkyl or polyfluoroalkyl substances (PFAS) from the group comprising the following substances:
perfluoro-octane sulfonate (PFOS); perfluoro-octanoic acid (PFOA); perfluoro-n-hexane sulfonic acid (PFHxS); perfluoro-nonanoic acid (PFNA); perfluoro-decanoic acid (PFDA/Ndfda); 6:2-fluorotelomer sulphonate compounds (6:2 FTS); 8:2-fluorotelomer sulphonate compounds (8:2 FTS); and perfluoro-octanoic acid (PFHpA); poly fluorinated carboxylic acids, alkyl sulfonates and alkyl sulfonamido compounds; and fluorotelemeric compounds, each having differing carbon chain lengths; and including precursors of these.

90. A method as claimed in any one of claim 79 to claim 81, or claim 84, wherein the preselected absorptive solid material is suitable for absorption of one or more perfluoroalkyl or polyfluoroalkyl substances (PFAS) from the group comprising the following amphiphilic substances: perfluoro-hexanoic acid (PFHxA); perfluoro-butane sulfonic acid, (PFBS); and perfluoro-pentane sulfonic acid (PFBeS).

91. A method as claimed in any one of claims 78 to 90, further comprising the step of removing solid material from the water prior to it flowing into the chamber.

92. A method as claimed in any one of claims 78 to 91, wherein further steps of the method are as claimed in any one of claims 2 to 7.

93. Apparatus for separating an amount of a substance from water which is contaminated with an initial concentration of the substance, the apparatus comprising one or more chambers which:
are arranged in use to admit the movement of said contaminated water via an inlet thereinto, until the chamber is filled to a pre-determined extent;
have a respective gas introduction device, in use the introduced gas for inducing the water in the chamber to flow, and for producing a froth layer which is formed at, and which rises above an interface with the said flow of water and introduced gas in the chamber, the froth layer including an amount of water and also a concentrated amount of the substance when compared with its initial concentration;
have a froth layer removal device in use for removing at least some of the froth layer from a respective upper portion of a chamber, such that during removal the froth layer collapses, prior to it passing to a secondary treatment device which uses one of the processes of absorption and filtration to remove said concentrated substance from the water; and
have an exit, in use to allow a discharge flow of remaining water therefrom.

94. Apparatus for separating an amount of a substance from water as claimed in claim 93, wherein the or each froth layer removal device includes mechanical apparatus from the group comprising: a foam breaker, a vacuum extraction device and a froth extraction head.

95. Apparatus for separating an amount of a substance from water as claimed in claim 93, wherein the secondary treatment device includes at least one of the group comprising: absorption using a pre-selected absorptive solid material; filtration using reverse osmosis membranes; vacuum distillation; drum drying.

96. Apparatus for separating an amount of a substance from water as claimed in claim 95, wherein the pre-selected absorptive solid material is at least one from the group comprising: an activated carbon; a clay; an ion exchange resin; a composite particle comprising an aggregate core which is surface-coated with a reactive absorbent material.

97. Apparatus for separating an amount of a substance from water as claimed in any one of claims 93 to 96, further comprising the features as claimed in any one of claim 27 to claim 70.
